(19) United States
(12) Patent Application Publication
(10) Pub. No.: US 2026/0228494 A1
(43) Pub. Date: Aug. 6, 2026

(54) TRANSITIVE AND COMMUTATIVE MULTIMODAL MODELS AND USES

(71) Applicants: Roche Diagnostics International AG, Rotkreuz (CH); Roche Diagnostics GmbH, Mannheim, DE (US)

(72) Inventors: Eldad Klaiman, Penzberg (DE); Amal Lahiani, Penzberg (DE); Manuel Tran, Penzberg (DE); Yashin Dicente Cid, Barcelona (ES)

(21) Appl. No.: 19/478,716

(22) PCT Filed: Apr. 24, 2024
(86) PCT No.: PCT/EP2024/061186

§ 371 Date: Oct. 24, 2025

Related U.S. Application Data
(60) Provisional application No. 63/462,825, filed on Apr. 28, 2023.

(51) Int. Cl. G06N 3/045

(52) U.S. Cl. CPC G06N 3/045

(57) ABSTRACT

Computer-implemented methods for analysing multimodal data are described. A computer-implemented method comprises generating an output data set by processing an input data set comprising data from one or more of a set of at least three modalities, using a machine learning model comprising a transitive and commutative machine-learning model. Related methods, products and systems are described.

### FIELD OF THE INVENTION

The present invention relates to computer implemented methods for analysing input data using a multimodal machine learning model trained using commutative modelling and transitive modelling, and computer implemented methods for training a multimodal machine learning model using commutative modelling and transitive modelling. Related systems and computer program products are also described.

### BACKGROUND

Integrating multiple modalities, such as images, text, or speech, promises to provide a more comprehensive and holistic understanding of otherwise intractable problems. By leveraging the unique and complementary strengths of each data type, this approach results in a more synergistic representation of the underlying phenomena-enabling deep learning systems to excel and adapt to real-world scenarios. Thus, there has been impressive progress in the field of multimodal learning in recent years. Most of this work has focused on multimodal datasets where all data points have all modalities (see FIG. 3a). Approaches that accommodate the use of data with missing modalities still rely heavily on at least a subset of samples where all modality combinations are present (see FIG. 3b). In practice, it is not easy to obtain such datasets when considering more than two modalities, e.g. three modalities. In the worst case, we might end up with a dataset containing only modalities A and B, and another disjoint dataset containing modalities B and C. Thus, the combination A and C is unconditionally missing (see FIG. 3c).

This is particularly important for safety-critical domains such as healthcare, infrastructure, and transportation. In medicine, for example, it is already difficult to obtain a large dataset with a single modality to train powerful foundation models-such as those used in general computer vision and natural language processing. Finding a dataset with two or more modalities is even more challenging. But combining them is important because it is common practice to look at different types of data, such as radiological images, genetic sequences, and microscopic slides, to determine the optimal treatment. Similarly, infrastructure monitoring models or automated driving systems require input from a variety of sensors. However, not all modality combinations might be present in the same training set.

Thus, there is a need for new methods to obtain multimodal models, that do not suffer from the drawbacks of the prior art.

### SUMMARY OF THE INVENTION

The present inventors sought to find a solution to the problem of pre-training a multimodal neural network that can handle any combination of modalities at inference time, when there are missing modalities in the pre-training data. They were particularly interested in developing an approach that can handle situations in which there are never seen combinations of modalities (e.g. (A,C) and (A,B,C) in the example on FIG. 1c). They sought to develop an approach that can do this and additionally enables to obtain a model that achieves better downstream performance the more modality combinations are given, including for the never-seen combinations (A,C) and (A,B,C).

To the best of the inventor's knowledge, this scenario had never been considered in the literature. The inventors designed a novel transitive pre-trained machine learning model termed LoReTTa, exemplified a transformer-based model, that can deal with such situations. LoReTTa (Linking modalities with a tRansitive and commutativE pre-Training sTrAtegy) can link modalities and transition between them using generative pre-training (predicting the next token), the commutative property (A,B)=(B,A), and the transitive relation (A→B)∧(B→C)⇒(A→C). The inventors further showed theoretically and experimentally that by learning the relationship within and between tokens from different data distributions, LoReTTa is well suited for training multimodal models. This has far-reaching implications for safety-critical domains such as healthcare, infrastructure, and transportation, as described above, where it is common that not all modality combinations might be present in the same training set. With LoReTTa, they demonstrated a unique way to address this challenging and under-researched problem.

Thus, in a first aspect, there is provided a computer-implemented method comprising: obtaining an input data set comprising data from one or more modalities selected from a set of at least three modalities; and generating an output data set by processing the input data set using a machine learning model comprising a transitive and commutative machine-learning model, wherein a transitive and commutative machine-learning model is a machine learning model that has been trained to transform input data sets corresponding to any and each of the modalities of the set of least three modalities to output data sets of any and each other of the modalities of the set of at least three modalities, wherein the machine learning model has been trained to transform data between two modalities by using training data that includes data pairs corresponding to a first of the two modalities and another modality and other data pairs corresponding to the other modality and a second of the two modalities, and the machine learning model has been trained to perform a corresponding reverse type of modality transformation for any forward type of modality transformation that the model has been trained to perform.

Also described according to the present aspect is a computer-implemented method comprising: accessing an input data set; determining a particular input modality of the input data set; receiving an indication of a particular target output modality; and generating an output data set by processing the input data set and an identification of the particular target output modality using a transitive and commutative machine-learning model, wherein the transitive and commutative machine-learning model is: configured to transform input data sets corresponding to any and each of at least three modalities to output data sets of any and each other of the at least three modalities; transitive in that it is configured to learn to transform data between two modalities by using training data that includes data pairs corresponding to a first of the two modalities and another modality and other data pairs corresponding to the other modality and a second of the two modalities; and commutative in that it is configured such that, for any forward type of modality transformation for which the transitive and commutative machine-learning model is configured to perform, the transitive and commutative machine-learning model is also configured to perform a corresponding reverse type of modality transformation.

The methods according to the present aspect may have any one or more of the following optional features.

The machine learning model may be a classification model, a regression model or a generative model. A classification model may comprise the transitive and commutative machine-learning model configured to take as input the input dataset, and a trained classification model trained to take as input extracted features from the transitive and commutative machine-learning model and produce as output a classification for the input dataset. A generative model may be trained to take as input the input dataset and produce as output a generated output data set corresponding to the input data set, wherein the output data set corresponds to a modality of the set of at least three modalities that is not present in the input dataset. A regression model may comprise the transitive and commutative machine-learning model configured to take as input the input dataset, and a trained regression model trained to take as input extracted features from the transitive and commutative machine-learning model and produce as output a regression value for the input dataset. A regression model may be a Cox Proportional-Hazards Model and the regression value may be a survival prediction. Obtaining an input data set can comprise accessing or receiving an input data set. Thus, the transitive and commutative machine-learning model can be describes as a machine learning model that is: (i) configured to transform input data sets corresponding to any and each of the modalities of the set of least three modalities to output data sets of any and each other of the modalities of the set of at least three modalities; (ii) transitive in that it is configured to learn to transform data between two modalities by using training data that includes data pairs corresponding to a first of the two modalities and another modality and other data pairs corresponding to the other modality and a second of the two modalities; and (ii) commutative in that it is configured such that, for any forward type of modality transformation for which the transitive and commutative machine-learning model is configured to perform, the transitive and commutative machine-learning model is also configured to perform a corresponding reverse type of modality transformation.

The method may comprise determining a particular input modality of the input data set, and receiving an indication of a particular target output modality; and generating an output data set is performed by processing the input data set and the identification of the particular target output modality using the transitive and commutative machine-learning model.

The transitive and commutative machine-learning model may have been trained using causal generative modeling, masked modeling and/or variations thereof. A variation may be causal masked modeling. The causal generative modelling, masked modeling, and/or variation thereof may have used ground truth data that comprised, for each of a plurality of data pairs in the training data, concatenated input data for a first modality and a second modality of a data pair, wherein the modality of the data pair used as the first modality was randomly sampled from the two modalities of the data pair. Instead or in addition to this, the ground truth data may have comprised for each of the plurality of data pairs in the training data first concatenated input data and second concatenated input data wherein the modality of the data pair used as the first modality is different between the first concatenated input data and second concatenated input data.

The transitive and commutative machine-learning model may be a sequence model, and/or a deep learning model. The transitive and commutative machine-learning model may comprise a sequence model selected from a recurrent neural network, a model combining recurrence and attention mechanisms, a convolutional neural network or a convolution-based model, optionally a model combining elementwise multiplication (gating) and long convolutions or a model combining convolutions and attention mechanisms, a state-space model or a model combining a state-space model and attention mechanisms, or a transformer-based model. A recurrent neural network may be a long short-term memory model (LSTM). A model combining recurrence and attention mechanisms may be a Receptance Weighted Key Value (RWKV) model or a Griffin model. A model combining elementwise multiplication (gating) and long convolutions may be a Hyena model. A model combining convolutions and attention mechanisms may be a Striped Hyena model. An attention-based model can also be referred to as a transformer-based model when it is an attention only model. A state-space model may be a Mamba or Hawk model. A model combining a state-space model and attention mechanisms may be referred to as a hybrid transformer-state space model. Examples include the Jamba model.

The transitive and commutative machine-learning model may have been trained using causal masked modeling so as to: identify a subset of tokens in a training data set, wherein the tokens in subset of tokens are at multiple positions within the training data set; append the training data set with the subset of tokens;

and add masks at the multiple positions within the training data set. The method may further comprise using an identification the masks of the multiple positions during the training.

The transitive and commutative machine-learning model may include a Transformer model that uses self-attention.

The method may further comprise receiving an initial data set, and generating the input data set by tokenizing the initial data set.

Generating the input data set may comprise tokenizing the initial data set and projecting the tokenised initial data set into a predetermined feature space using a parameterized embedding function for each modality. Generating the input data set may comprise prepending and/or appending a modality specific token to the tokenised and optionally projected data corresponding to each single modality in the input data set Generating the input data set may comprise including learned positional embeddings.

The method may further comprise accessing another input data set related to the input data set; and determining another particular input modality of the other input data set, wherein the processing performed to generate the output data set further includes processing the other data set and an identification of the other particular input modality using the transitive and commutative machine-learning model.

The transitive and commutative machine-learning model may have been trained using a method comprising the steps of: accessing a training data set that included first data of the particular input modality and corresponding second data of the other modality; generating a first predicted output data set by processing the first data and an identification of the other modality using the transitive and commutative machine-learning model, wherein the first predicted output data set corresponds to the other modality; generating a second predicted output data set by processing the first predicted output data and an identification of the particular target output modality using the transitive and commutative machine-learning model, wherein the second predicted output data set corresponds to the particular target output modality; generating a third predicted output data set by processing the second predicted output data and an identification of the particular input modality using the transitive and commutative machine-learning model, wherein the third predicted output data set corresponds to the particular input modality; and computing a loss by comparing at least part of the third predicted output data set to the first data.

The transitive and commutative machine-learning model may have been trained using training data that lacked data associating first data of the particular input modality with second data of the particular output modality. The transitive and commutative machine-learning model may have been trained using training data that comprised data associating data of pairs of modalities of the set of at least three modalities, wherein for each pair of a first and second modality of the set of at least three modalities, the training data comprised data associating data of pairs of modalities that together form a path between the first and second modality. In embodiments, for each pair of a first and second modality of the set of at least three modalities, the training data comprised data associating data of the first modality with a third modality and data associating data of the third modality with the second modality. Thus, the training data may have not included training data that associates any pair of modalities but may have included data that associates the modalities in the missing pair using one or more bridging (also referred to herein as “linking”) modalities.

The transitive and commutative machine-learning model may have been trained using a first step using commutative modeling and a self-supervised learning objective, and a second step in which the machine learning model weights are initialized to the weights learned in the first step and further trained using transitive modeling. The first step may have comprised training the model to take as input a partially masked concatenated input data for a first modality and a second modality of a data pair in a training data set comprising ground truth data for a plurality of data pairs each comprising corresponding data for a pair of modalities, and produce as output a prediction of the masked input data, wherein the modality of the data pair used as the first modality was randomly sampled from the two modalities of the data pair and/or the ground truth data comprised for each of the plurality of data pairs in the training data first concatenated input data and second concatenated input data wherein the modality of the data pair used as the first modality is different between the first concatenated input data and second concatenated input data.

The second step may have comprised training the model to, for each of a plurality of data pairs of a training dataset, each comprising first data for a first modality and corresponding second data for a second modality of the set of at least three modalities: predicting third data for a third modality of the set of at least three modalities corresponding to the second data using the machine-learning model taking as input the second data; optionally iteratively predicting subsequent data for a further modality of the set of at least three modalities corresponding to the predicted third data or predicted subsequent data using the transitive and commutative machine-learning model taking as input the predicted third data or predicted subsequent data; predicting final data for the first modality corresponding to the predicted third data or latest iteratively predicted subsequent data using the transitive and commutative machine-learning model taking as input the third data or latest iteratively predicted subsequent data; a loss that compares the first data and the predicted final data; wherein the training data comprised: (i) pairs comprising data for the second modality and corresponding data for the third modality, and (ii) pairs comprising data for the third modality and corresponding data for the first modality, or pairs comprising data for the latest further modality and corresponding data for the first modality and respective pairs comprising data for each of the two modalities used in the step of iteratively predicting subsequent data for a further modality.

Training the model using commutative modeling and a self-supervised learning objective may comprise or may have comprised training the model to take as input a partially masked concatenated input data for a first modality and a second modality of a data pair in a training data set comprising ground truth data for a plurality of data pairs each comprising corresponding data for a pair of modalities, and produce as output a prediction of the masked input data, wherein the modality of the data pair used as the first modality was randomly sampled from the two modalities of the data pair and/or the ground truth data comprised for each of the plurality of data pairs in the training data first concatenated input data and second concatenated input data wherein the modality of the data pair used as the first modality is different between the first concatenated input data and second concatenated input data.

Training the model using transitive modeling may comprise or may have comprised training the model to, for each of a plurality of data pairs of a training dataset, each comprising first data for a first modality and corresponding second data for a second modality of the set of at least three modalities: predicting third data for a third modality of the set of at least three modalities corresponding to the second data using the machine-learning model taking as input the second data; predicting final data for the first modality corresponding to the predicted third data using the transitive and commutative machine-learning model taking as input the third data; and computing a loss that compares the first data and the predicted final data; wherein the training data comprised: (i) pairs comprising data for the second modality and corresponding data for the third modality, and (ii) pairs comprising data for the third modality and corresponding data for the first modality.

Training the model using transitive modeling may comprise and may have comprised training the model to, for each of a plurality of data pairs of a training dataset, each comprising first data for a first modality and corresponding second data for a second modality of the set of at least three modalities: predicting third data for a third modality of the set of at least three modalities corresponding to the second data using the machine-learning model taking as input the second data; iteratively predicting subsequent data for a further modality of the set of at least three modalities corresponding to the predicted third data or predicted subsequent data using the transitive and commutative machine-learning model taking as input the predicted third data or predicted subsequent data; predicting final data for the first modality corresponding to the predicted latest iteratively predicted subsequent data using the transitive and commutative machine-learning model taking as input the latest iteratively predicted subsequent data; and computing a loss that compares the first data and the predicted final data; wherein the training data comprised: (i) pairs comprising data for the second modality and corresponding data for the third modality, and (ii) pairs comprising data for the latest further modality and corresponding data for the first modality and respective pairs comprising data for each of the two modalities used in the step of iteratively predicting subsequent data for a further modality.

The transitive and commutative machine-learning model may have been trained to learn a first conditional distribution (P(C|A), P(A|C)) of a pair of modalities (A, C) for which the training data did not contain sufficient training data pairs associating data of the pair of modalities to parameterise the conditional distribution, by predicting data for one or more additional modalities (B) forming a link between the pair of modalities using learned further conditional distributions (P(C|B)) of pairs of modalities (C, B) forming said link and for which the training data did contain sufficient training data pairs associating data of the pair of modalities to parameterise the further conditional distributions.

The transitive and commutative machine-learning model may have been trained using training data comprising tuples (e.g. pairs) comprising corresponding data for multiple modalities of the set of at least three modalities, wherein the tuples including data for a specific pair of modalities of the set of at least three modalities were present in the training data at less than 50%, less than 40%, less than 30%, less than 20%, less than 10%, less than 5% or less than 1% of the number of tuples including data for all other pairs of modalities of the set of at least three modalities. In embodiments, the tuples did not comprise tuples that include data for a specific pair of modalities of the set of at least three modalities.

The method may further comprise training the machine learning model.

The one or more modalities may be selected from medical or biological sample data associated with a subject. The one or more modalities may be selected from: medical image data, electronic-medical-record data, genetic sequence data, and digital pathology image data. The medical image data may be selected from MRI, CT or PET imaging data. Thus, the particular input modality or the target output modality may include MRI, CT, or PET imaging. The particular input modality or the target output modality may include electronic-medical-record representation. The particular input modality or the target output modality may include genetic-sequence representation. The particular input modality or the target output modality may include digital pathology imaging.

The machine learning model may be configured to take as input medical or biological sample data associated with a subject and produce as output an indication of a treatment that is recommended for the subject. The indication may be a classification. The medical or biological sample data may comprise one or more of: as radiological images, genetic sequences, and microscopic slides.

The machine learning model may be configured to take as input data collected by any one or more of multiple types of sensors associated with a vehicle, optionally an automobile, and to generate as output predicted sensor data for another type of sensor data associated with the vehicle. The machine learning model may have been trained using synchronized data from pairs of the multiple types of sensors. According to a second aspect, there is provided a computer-implemented method comprising: input medical or biological sample data associated with a subject using the method of any embodiment of the first aspect; and providing a diagnosis and/or prognosis and/or treatment recommendation for the subject using the output of the machine learning model, wherein the output of the machine learning model is indicative of the diagnosis, prognosis or treatment recommendation. According to a third aspect, there is provided a computer-implemented method of training a multimodal machine-learning model, the method comprising: accessing a training data set comprising data for each of a set of at least three modalities; and training a machine learning model to transform input data sets corresponding to any and each of the modalities of the set of least three modalities to output data sets of any and each other of the modalities of the set of at least three modalities, wherein the machine learning model is trained to transform data between two modalities by using training data that includes data pairs corresponding to a first of the two modalities and another modality and other data pairs corresponding to the other modality and a second of the two modalities, and the machine learning model is trained to perform a corresponding reverse type of modality transformation for any forward type of modality transformation that the model is trained to perform.

Also described according to the present aspect is a computer-implemented method for obtaining a trained transitive and commutative machine-learning model, wherein: the trained transitive and commutative machine-learning model is configured to transform input data sets corresponding to any and each of at least three modalities to output data sets of any and each other of the at least three modalities; the trained transitive and commutative machine-learning model is transitive in that it is configured to learn to transform data between two modalities by using training data that includes data pairs corresponding to a first of the two modalities and another modality and other data pairs corresponding to the other modality and a second of the two modalities; and the trained transitive and commutative machine-learning model is commutative in that it is configured such that, for any forward type of modality transformation for which the transitive and commutative machine-learning model is configured to perform, the transitive and commutative machine-learning model is also configured to perform a corresponding reverse type of modality transformation; and wherein the method comprises one or both of: (i) training the machine learning model using causal masked modeling so as to: identify a subset of tokens in a training data set, wherein the tokens in subset of tokens are at multiple positions within the training data set; append the training data set with the subset of tokens; and add masks at the multiple positions within the training data set; and (ii) accessing a training data set that included first data of a particular input modality of the at least three modalities and corresponding second data of another modality of the at least three modalities; generating a first predicted output data set by processing the first data and an identification of the other modality using the transitive and commutative machine-learning model, wherein the first predicted output data set corresponds to the other modality; generating a second predicted output data set by processing the first predicted output data and an identification of the particular target output modality using the transitive and commutative machine-learning model, wherein the second predicted output data set corresponds to the particular target output modality; generating a third predicted output data set by processing the second predicted output data and an identification of the particular input modality using the transitive and commutative machine-learning model, wherein the third predicted output data set corresponds to the particular input modality; and computing a loss by comparing at least part of the third predicted output data set to the first data.

The method of the present aspect may have any of the features described in relation to the first aspect. The methods according to the present aspect may have any one or more of the following optional features.

Training the machine learning model may comprise using causal generative modeling, masked modeling and/or causal masked modeling, wherein: said causal generative modelling, masked modeling, and/or causal masked modeling uses ground truth data from said training data set that comprises, for each of a plurality of data pairs in the training data, concatenated input data for a first modality and a second modality of a data pair, wherein the modality of the data pair used as the first modality is randomly sampled from the two modalities of the data pair and/or the ground truth data comprises for each of the plurality of data pairs in the training data first concatenated input data and second concatenated input data wherein the modality of the data pair used as the first modality is different between the first concatenated input data and second concatenated input data.

The training may use ground truth data from said training data set that comprises, for each of a plurality of data pairs in the training data, concatenated input data for a first modality and a second modality of a data pair, wherein the modality of the data pair used as the first modality is randomly sampled from the two modalities of the data pair with a predetermined probability, optionally a 50% probability.

Training the machine-learning model may comprise learning a first conditional distribution (P(C|A), P(A|C)) of a pair of modalities (A, C) for which the training data does not contain sufficient training data pairs associating data of the pair of modalities to parameterise the conditional distribution, by using the machine-learning model to predict data for one or more additional modalities (B) forming a link between the pair of modalities, said predicting using learned further conditional distributions (P(C|B)) of pairs of modalities (C, B) forming said link and for which the training data did contain sufficient training data pairs associating data of the pair of modalities to parameterise the further conditional distributions.

Training the machine-learning model may comprise, for each data pair of the training data comprising data pairs comprising first data for a first modality and corresponding second data for a second modality of the set of at least three modalities: predicting third data for a third modality of the set of at least three modalities corresponding to the second data using the transitive and commutative machine-learning model taking as input the second data; predicting final data for the first modality corresponding to the predicted third data using the transitive and commutative machine-learning model taking as input the third data or latest iteratively predicted subsequent data; and computing a loss that compares the first data and the predicted final data; wherein the training data comprised: (i) pairs comprising data for the second modality and corresponding data for the third modality, and (ii) pairs comprising data for the third modality and corresponding data for the first modality.

Training the machine-learning model may comprise, for each data pair of the training data comprising data pairs comprising first data for a first modality and corresponding second data for a second modality of the set of at least three modalities: predicting third data for a third modality of the set of at least three modalities corresponding to the second data using the transitive and commutative machine-learning model taking as input the second data; iteratively predicting subsequent data for a further modality of the set of at least three modalities corresponding to the predicted third data or predicted subsequent data using the transitive and commutative machine-learning model taking as input the predicted third data or predicted subsequent data; predicting final data for the first modality corresponding to the latest iteratively predicted subsequent data using the transitive and commutative machine-learning model taking as input the third data or latest iteratively predicted subsequent data; and computing a loss that compares the first data and the predicted final data; wherein the training data comprised: (i) pairs comprising data for the second modality and corresponding data for the third modality, and (ii) pairs comprising data for the latest further modality and corresponding data for the first modality and respective pairs comprising data for each of the two modalities used in the step of iteratively predicting subsequent data for a further modality.

Training the machine learning model may comprise using causal masked modeling so as to: identify a subset of tokens in a training data set, wherein the tokens in subset of tokens are at multiple positions within the training data set; append the training data set with the subset of tokens; and add masks at the multiple positions within the training data set.

Training the machine learning model may comprise: accessing a training data set that includes first data of a particular input modality of the at least three modalities and corresponding second data of another modality of the at least three modalities; generating a first predicted output data set by processing the first data and an identification of the other modality using the transitive and commutative machine-learning model, wherein the first predicted output data set corresponds to the other modality; generating a second predicted output data set by processing the first predicted output data and an identification of the particular target output modality using the transitive and commutative machine-learning model, wherein the second predicted output data set corresponds to the particular target output modality; generating a third predicted output data set by processing the second predicted output data and an identification of the particular input modality using the transitive and commutative machine-learning model, wherein the third predicted output data set corresponds to the particular input modality; and computing a loss by comparing at least part of the third predicted output data set to the first data.

The method may further comprise training a further machine learning model comprising the trained machine learning model, wherein the further machine learning model is trained for a specific task and is a classification model, a regression a generative model. The classification model may comprise the trained machine-learning model, and a classification model trained to take as input extracted features from the transitive and commutative machine-learning model and produce as output a classification for an input dataset that was provided to the trained machine-learning model, optionally wherein the classification model is trained using training data comprising data for one or more of the set of at least three modalities and associated ground truth classification labels. The generative model may be trained to take as input an input dataset and produce as output a generated output data set corresponding to the input data set, wherein the output data set corresponds to a modality of the set of at least three modalities that is not present in the input dataset, optionally wherein the trained machine learning model is used as the generative model or the trained machine learning model is fine-tuned using further training data to obtain the generative model. The generative model may be trained to take as input an input dataset comprising missing data and produce as output a generated output data set corresponding to the missing data in the input data set, optionally wherein the trained machine learning model is used as the generative model or the trained machine learning model is fine-tuned using further training data to obtain the generative model. The regression model may comprise the trained machine-learning model, and a regression model trained to take as input extracted features from the trained machine-learning model for an input dataset and produce as output a regression value for the input dataset. In embodiments, the regression model is a Cox Proportional-Hazards Model and the regression value is a survival prediction and/or wherein the regression model is trained using training data comprising data for one or more of the set of at least three modalities and associated ground truth regression values.

According to any embodiment of any aspect, obtaining or accessing input data (such as e.g. medical data or biological sample data) may comprise a processor receiving the input data from a database, data acquisition means (e.g. medical data mage acquisition means, biological sample data acquisition means such as a microscope, sequencer or computing device associated therewith), computer readable medium, user interface or computing device.

The methods of any aspect may comprise providing to a user, for example through a user interface, one or more results of the methods. For example, results may include a classification prediction, a regression prediction, a predicted output data associated with one or more of the plurality of modalities (e.g. output of a generative model), one or more trained parameters of the trained machine learning model, the trained machine learning model, and/or any information derived therefrom. A data store may be a public or private database. Information derived from a classification prediction may comprise one or more of: a prognostic indication derived from a classification obtained using the machine learning model, a therapeutic indication derived from a classification obtained using the machine learning model, an indication of suitability for taking part in a clinical trial derived from a classification obtained using the machine learning models, etc.

According to a fourth aspect, there is provided a system comprising: one or more processors and one or more computer readable memory storing instructions that cause the one or more processors to perform any method described herein, such as the method of any embodiment of any preceding aspect, including in particular any embodiment of the first, second and/or third aspect. In some embodiments, the system may comprise one or more computers, servers, or cloud-based devices, for example.

According to a fifth aspect, there is provided a non-transitory computer readable storage medium containing machine executable instructions which, when executed on a processor, cause the processor to perform any method described herein, such as the method of any embodiment of the first, second and/or third aspect, including any one, or any combination insofar as they are compatible, of the optional features set out with reference thereto.

According to a sixth aspect, there is provided a computer program comprising executable code which, when run on a computer, causes the computer to perform the method of any embodiment of any method described herein such as the method of any embodiment of the first, second and/or third aspect, including any one, or any combination insofar as they are compatible, of the optional features set out with reference thereto.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a flow diagram of a method using and/or obtaining a multimodal model according to the disclosure.

FIG. 2 shows an embodiment of a system according to the present disclosure.

FIG. 3a, b, c show Venn diagrams showing the relationship between datasets with different modalities A, B, and C. Overlapping datasets indicate that the dataset contains samples with aligned modalities (i.e., audio, image, and text files belonging to the same concept). While recent work has mostly focused on datasets where at least some samples have all modality combinations available (a, b), embodiments of the present disclosure consider cases where some modality combinations, e.g. (A, C) and (A, B, C), are missing entirely (c).

FIG. 4a, b, c, d illustrate schematically training strategies for a multimodal model according to embodiments of the disclosure (LoReTTa). The figure illustrates two novel self-supervised strategies: commutative and transitive modeling. (a) Commutative modelling as illustrated applies causal modeling in a commutative manner to generate modality A from B and modality B from A—given the aligned input sample (A, B). For the aligned but disjoint data point (B′, C), the same technique is applied. (b) To ensure that the model learns bidirectional relations between the input tokens, the illustrated embodiment uses a modified variant of generative pre-training called causal masked modeling. (c, d) Transitive pre-training is used to learn any missing conditional joint distributions. This randomly selects a sample and uses the linking modality B to predict the missing modality C, which is then used to reconstruct the existing modality A. The last step ensures that all modalities are properly aligned.

FIG. 5 illustrates the properties of training and testing data used in an example of the disclosure (SVL-MNIST dataset).

FIG. 6 illustrates the properties of training and testing data used in an example of the disclosure (TCGA-OMICS dataset).

FIG. 7 shows pseudocode illustrating the pre-training of a model according to an example of the disclosure. The figure outlines the main ideas and algorithmic steps to train a model using commutative and transitive modelling, and how both are integrated into the causal modeling framework.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The methods described herein are computer implemented unless context indicates otherwise. Indeed, image analysis using deep learning models, and the process of training deep learning models is of a complexity, and in particular requires the analysis of large amounts of data through complex mathematics, that places the methods described herein far beyond the capability of mental investigation. Thus, any method described herein may be implemented in a computer system (in particular in computer hardware or in computer software) in addition to the structural components and user interactions described.

The term “computer system” includes the hardware, software and data storage devices for embodying a system or carrying out a method according to the above-described embodiments. For example, a computer system may comprise one or more processing units such as central processing units (CPU) and/or graphics processing units (GPU), input means, output means and data storage. Preferably the computer system has a monitor to provide a visual output display. The data storage may comprise RAM, disk drives or other computer readable media. The computer system may include a plurality of computing devices connected by a network and able to communicate with each other over that network. It is explicitly envisaged that the computer system may consist of or comprise a cloud computer.

The methods described herein may be provided as computer programs or as computer program products or computer readable media carrying a computer program which is arranged, when run on a computer, to perform the method(s) described herein. The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

The features disclosed in the following description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention will be described in conjunction with the exemplary embodiments described below, many equivalent modifications and variations will be apparent to those skilled in the art when given this disclosure. Accordingly, the exemplary embodiments of the invention set forth below are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations. Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps. As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%. The expression “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

The present disclosure generally relates to multimodal machine learning model that are trained using commutative modelling and transitive modelling. Such models may be referred to herein as “transitive and commutative models”, or simply “machine learning models” or “models”, as the properties of transitivity and commutativity are inherent properties of the models described herein resulting from the way in which they have been trained.

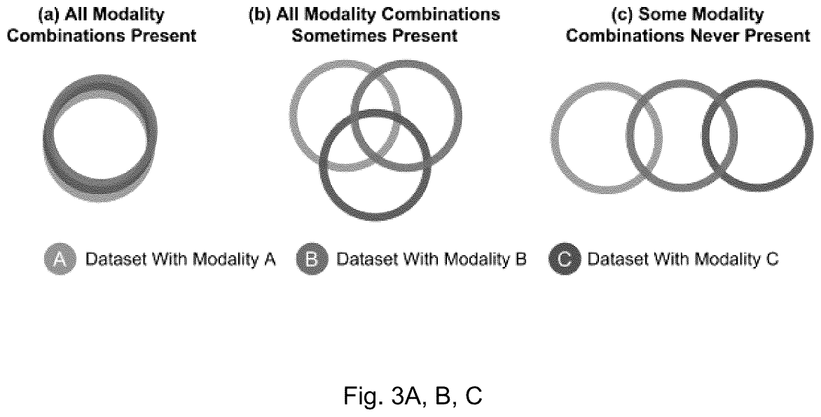

A multimodal machine learning model is a model that is trained using multiple modalities of data. For example, a multimodal model may be trained using image and text data. Multimodal models are assumed to be able to learn a more robust representation of underlying phenomena represented in the data. For example, multimodal models can be used to classify images using both the image content and an associated caption text, or to predict a caption text for an input image. Multimodal models are typically trained using data comprising corresponding observations for each of the multiple modalities modelled. These can also be referred to as tuples or aligned data. For example, the above text and image multimodal models are trained using paired image and caption data points. This is both inflexible (as it is necessary to know at the outset of the training process, what data will be available at model deployment time), and often unrealistic when using more than two modalities (since data sets including aligned data for 3 or more modalities are rare in real world scenarios). Collecting a multimodal dataset with two paired modalities A and B or B and C is difficult in practice. Obtaining datasets with three aligned modalities A, B, and C may be even more difficult, and importantly, potentially more unreliable. The number of potential relationships between a dependent variable and independent variables exponentially scales depending on the number of independent variables and the intermediate transformations between the independent variables and the dependent variables. Therefore, the extent to which a data set of a given modality can be used to predict data from another modality depends on the complexities of the data in the two modalities and the relationships. These complexities compound when data from more than two data sets are considered. For example, FIG. 3a represents a scenario when data from three modalities is available. FIG. 3b represents a scenario where some entries of various modalities have corresponding data from one other modality, some other entries have corresponding data from two other modalities, and other entries do not have corresponding data from any other modality. FIG. 3c represents a scenario where some of the entries in a first modality have corresponding data in a second modality but none of the entries in the first modality have corresponding data in a third modality. It is indeed not unusual that data of a given modality of interest is not available for training a model, even if other potentially pertinent data is available. For example, if in some cases, only modalities A and B are paired; and if in others, only modalities B and C are paired. The combination A and C may be unconditionally missing, though predicting data from modality C based on data from modality A (or based on data from modalities A and B) may be of interest. Further yet, identifying data sets across modalities that are reliably associated is particularly difficult when timing may be important. For example, the degree to which results from multiple medical tests can be meaningfully associated with each may depend on the relative timing of the tests, the precision of the tests, the reliability of the tests and/or the subject condition. Thus, situations in which some pairs of data modalities are mostly or entirely absent from a training data set used to train a multimodal model are frequent, and existing multimodal learning methods are not able to adequately deal with these.

With the introduction of transformers, the fields of natural language processing (NLP) and computer vision (CV) have experienced a significant shift in performance and capabilities. These models excel at a wide range of complex tasks, including machine translation, text summarization, question answering, sentiment analysis, natural language generation, image classification, image captioning, semantic segmentation, object detection, and face recognition-achieving state-of-the-art performance in each area. Transformers have also opened up new possibilities for multimodal learning due to their lack of inductive bias. They can process and fuse different types of data, such as audio, image, video, and text, using self- and cross-attention mechanisms. As a result, transformers are considered to be universal, modality-agnostic learners.

However, their lack of inductive bias comes at a price. Unlike other neural network architectures, transformers make few assumptions about the structure of the data. This makes them highly expressive, but they also require a large amount of data to learn effectively and generalize well [Hoffmann et al. 2022]. Consequently, self-supervised learning (SSL) on large amounts of unlabeled data has been proposed for transformers. In NLP, this strategy has been very successful, with methods such as masked modeling and causal modeling used to train large language models (LLMs) such as BERT [Devlin et al. 2019] and GPT [Radford et al. 2018] variants. Recently, attempts have been made to unify masked modeling and causal modeling through frameworks like prefix modeling, permutation modeling, causal masked modeling [Aghajanyan et al. 2022], or unified language learning. When applied to image classification, token-based pre-training methods have demonstrated their ability to outperform established computer vision approaches such as SimCLR [Hayes et al. 2022] and DINO [Caron et al. 2021]. As a result, these sequence modeling techniques have been successfully adapted and extended to a wide range of domains, encompassing programming, biochemistry, and reinforcement learning.

Adding or combining different modalities to the training process could open up three possibilities: positive transfer, cross-modal understanding, and cross-modal generation. Positive transfer occurs when learning in one modality helps to improve performance in another modality. For example, it has been shown that aligning images with text leads to better classification performance on ImageNet [Radford et al. 2021b]. Cross-modal understanding refers to the explanation of one modality in terms of the other. Models with this capability can describe an image using text [Alayrac et al. 2022] or infer protein structures from sequences [Jumper et al. 2021]. With cross-modal generation, one can even generate one modality using the other. Examples are text-to-image generation and text-to-music generation. Many modern multimodal foundation models are based on either contrastive learning [Girdhar et al. 2023], masked modeling [Wang et al. 2022], or causal modeling [Yu et al. 2022].

The present disclosure presents a novel pre-training method that combines advances in self-supervised learning into a unified framework. In embodiments, LoReTTa uses an approach that combines causal modeling and masked modeling for self-supervised learning of a multimodal model. The proposed method extends both approaches by using commutative and transitive modeling to seamlessly integrate and impute modalities. This allows the model to learn expressive features and relationships within multimodal datasets. The pre-trained models can be used for various downstream tasks such as infilling, classification, survival prediction, or cross-modal generation.

Multimodal models have been previously proposed. For example, the RNN-based model MCTN (multimodal cyclic translation network model, Pham et al. 2019) is a neural model that learns joint representations of multimodal data using modality translations. The model is based on the insight that translation from a source modality to a target modality results in an intermediate representation that captures joint information between the modalities, using only the source modality at test time. The approach differs from the present approach in several ways: it can only be used as a classifier, does not model all combinations of modalities, and most importantly requires all modalities to be aligned and present at training time. The methods described herein, on the other hand, do not need such strong assumptions. Models such as GPT, BERT, and derivatives (e.g. the transformer-based models CM3 and C2M3 used in the examples below) are able to make multimodal predictions using e.g. cross-attention. However, they do not learn a joint representation by generating missing modalities at training time, and their performance is therefore typically poor in the presence of missing modality pairs in the training data. Performance can be improved with much larger amounts of training data but this still does not compare with the methods described herein in terms of leveraging the additional information present in not fully aligned multimodal data. In other words, given any multimodal training data set comprising not fully aligned multimodal data, the methods described herein are expected to outperform models such as BERT and GPT because they are specifically designed to leverage the information present in the multimodal data even in the presence of not fully aligned data, by generating the missing modalities to connect between pairs of observations in a bidirectional manner, at training time (i.e. using transitive and commutative modeling as described herein). Further, in cases where a pair of modalities is always absent in the training data, these models will not be able to learn the relationship between these modalities. Models specifically designed for multimodal learning such as CLIP (Khosla et al. 2020) can handle training data sets that have missing modalities. CLIP jointly trains an image encoder and a text encoder to predict which of all possible pairs of a set of N text and N images were actual pairs, using a contrastive loss that maximize the cosine similarity of the image and text embeddings of the N real pairs in the set while minimizing the cosine similarity of the embeddings of the incorrect pairings. This enables to learn superficial features but does not explicitly model missing modalities and its performance therefore degrades quickly when the training data includes pairs of modalities that are mostly or always absent. Additionally, CLIP requires large amounts of data for training, making it computationally costly. By contrast, by explicitly modeling missing modalities using transitive and commutative modeling as described herein, the present methods are able to provide models with improved performance compared to all of the models above, as demonstrated in the examples below. As also demonstrated in the examples below, the performance of comparative models can be improved by increasing the computational power used for training. For example, when CLIP was trained for 3 times longer, with a larger batch size (5×), the performance did improve but still did not match that of the new models described herein. Therefore, the present disclosure provides models that are able to obtain levels of performance that may only be achievable with comparative models through the use of much larger amounts of training data and/or more computationally intensive training schemes, both of which effectively amount to the presently described models providing more computationally efficient approaches for training multimodal models in the presence of missing modalities in the training data.

The terms “analysing” and “processing” may be used interchangeably in the context of applying the models described herein to input data, as the models described are trained to analyse input data by processing said data.

The machine learning model may be a deep learning model. The machine learning model may be a sequence model. A sequence model is machine learning model that takes a sequence of data as input. A sequence of data is any string of input data that has a sequence (order). This is by contrast to a set of input data that representing a set of independent data points. A sequence model is typically a deep learning model. A deep learning model can be a deep neural network, such as: (i) a recurrent neural network (RNN) or RNN-based model, such as a model combining recurrence and attention mechanisms such as Receptance Weighted Key Value (RWKV) models (Peng et al. 2023) and Griffin (De et al. 2024), or a long short-term memory (LSTM) model, (ii) a convolutional neural network (CNN) or a convolution-based model such as a model combining elementwise multiplication (gating) and long convolutions (convolutions with filter sizes as long as the input) such as Hyena (Poli et al. 2023) or a model combining convolutions and attention mechanisms such as Striped Hyena (Poli et al., 2023b), (iii) a state-space model such as Mamba (Gu et al. 2023) or Hawk (De et al., 2024), or hybrid transformer-state space model such as Jamba (Lieber et al., 2024), or (iv) a fully attention-based model, also referred to as transformer-based model. In embodiments, the machine learning model is a transformer-based model. In other words, any machine learning model as described herein may include a transformer model. The machine-learning model may include a transformer model that uses self-attention. Transformer models can solve complex and diverse tasks such as machine translation, text summarization, question answering, sentiment analysis, natural language generation, image classification, object detection, face recognition, and image captioning-resulting in state-of-the-art performance in each area. Due to the lack of inductive bias, transformers can be well-suited for multimodal learning. Different types of data such as audio, image, text, and video can be processed and fused together using self- and cross-attention mechanisms. Thus, transformers are considered to be universal, and learners that are modality-agnostic.

Transformer-based models are a class of machine learning models, in particular deep learning models, that include attention mechanisms (self- and/or cross-attention mechanisms). Transformer-based models primarily or exclusively rely on attention mechanisms to learn from tokens in context, and typically do not rely on a recurrent structure for this. The attention mechanism in a transformer uses a plurality of scaled dot-product attention units. Attention units produce embeddings for every token that contain information about the token itself and a weighted combination of other relevant tokens (weighted by attention weights). In particular, each attention unit is associated with three learned weight matrices: the query weights W_{Q}, the key weights W_{K} and the value weights W_{V}. The input embedding xᵢ of each token i is multiplied by each of the three weight matrices to obtain the query vector qᵢ, key vector kᵢ and value vector vᵢ, respectively. In the original transformer and in ViT, attention weights from token i to token j are calculated as the dot product between qi and kj. These are then scaled by d where \sqrt{dₖ} is the dimension of the key vector. The scaled attention weights are passed through a softmax function, and this is multiplied by the value vector, i.e. the output of the attention unit for token i is a weighted sum of the values vectors of all tokens, weighted by the attention weight from token i to each of the respective tokens. Any machine learning model comprising an attention mechanism as described above or a derivative therefrom may be referred to as a transformer-based model in the context of the present disclosure. For example, derivatives of the original transformer above include a relative position bias B to each head. One set of learned matrices W_{Q}, W_{K} and W_{V} forms an attention head. Transformer models typically comprise a plurality of attention heads in each of a plurality of layers. Indeed, to extract more information, the attention mechanism can be repeated h times in parallel. Each attention head attends to the tokens that are relevant to each of the input tokens, and the use of multiple attention heads means that this can be repeated for different definitions of what is relevant. The outputs of the multiple attention heads in a layer are then concatenated and projected using a final projection matrix W^{Q} which is learned for each multi-head attention unit. Additional layers may be present. For example, a fully-connected layer typically follows the attention layer. This may comprise one or more further transformations (e.g. two linear transformations in a typical transformer) and/or one or more activation functions (e.g. ReLU activation in the original transformer, although other activation functions have been proposed such as GELU). Around each of the two sub-layers of the fully connected layer, the original transformer employs residual connections. All together these components (multi-head attention and subsequent fully-connected layer with residual connections) make up one encoder or decoder block which are repeated n times to produce a transformer-based encoder or decoder. The output of an encoder can be further processed to produce a prediction for a particular task. For example, the output of the encoder can be processed by a decoder with a similar architecture for generative tasks. Decoder blocks include a self-attention mechanism, an attention mechanism over the encodings, and a feed-forward neural network. As another example, the output of the encoder can be processed for classification using a classification head such as a multilayer perceptron (MLP). For example, class tokens can be prepended to the embeddings of an input, and a MLP can be used to compute logits for the class tokens from the output of the encoder.

As explained above, trained multimodal models according to the present disclosure can be further trained or used for any downstream task for which a pretrained multimodal sequence model can be used. In particular, the pretrained models can be applied to (and improve on prior art methods in the context of) any of positive transfer, cross-modal understanding, and cross-modal generation. Positive transfer refers to a situation in which training a multimodal learning helps to improve performance for a downstream task for which the model is used compared to performing the same task with an equivalent model trained using a single modality. The multimodal model can be used in the downstream task using a single or multiple modalities. For example, a multimodal model can be trained using aligned images and text data, and subsequently used for image classification using only images as inputs. Cross modal understanding refers to a situation in which one modality is explained in terms of another modality. For example, a model can be trained to describe an image using text and answer text-based questions about the image. Cross-modal generation refers to the generation of one or more modalities using one or more other modalities. Positive transfer and cross modal understanding can be leveraged in many downstream tasks including classification, regression, etc. Further, cross-modal generation can be used to transform data between modalities.

Specifically, the present disclosure relates to computer implemented methods for training a multimodal machine learning model using commutative modelling and transitive modelling, where the resulting model can be further trained (also referred to as fine-tuning or transfer learning) and/or included as part of a machine learning model comprising additional machine learning modules (e.g. a classification model, regression model or generative layers) that are trained for any downstream task of interest. Such a model may be referred to as a “foundation model”, and the derivative models trained for a downstream task may be referred to as “task-specific models”. The training and use of both types of models is explicitly encompassed in the present disclosure.

Thus, some embodiments of the present disclosure include training and/or using a machine-learning model to transform data between modalities. The machine-learning model may be configured and/or trained to operate in a commutative and/or transitive manner. Accordingly, the machine-learning model may be trained to receive inputs of any combination of multiple modalities (e.g., three or more modalities) as input and to transform the input to an output of any of the other multiple modalities. The model can link modalities and transition between them using generative pre-training, commutativity (A, B)=(B, A), and the transitive relation (A→B)∧(B→C)⇒(A→C). The machine learning model can include a novel LoReTTa (Linking modalities with a tRansitive and commutativE pre-Training sTrAtegy) approach, as will be described further below. The machine-learning model may have been trained using a self-supervised framework that uses the rules of commutativity and/or transitivity to transition between different modalities and causal generative pre-training. Thus, it can learn the relation modality A→modality C using modality A→modality B→modality C. Given a dataset containing only the combination (A, B) and (B, C), a transformer (or any general neural sequence model) pre-trained in accordance with techniques disclosed herein can handle any modality combination at inference time after fine-tuning on a downstream task, including the never-seen pair (A, C) and the triplet (A, B, C) while matching the performance of an oracle model (a model that has been trained with combinations (A,B,C) for all entries).

Methods of the present disclosure may comprise training a model using transfer learning. Transfer learning is a machine learning technique where a model is pretrained to perform a first task, then used (alone or as part of a machine learning model that includes additional machine learning modules such as a classification head, regression head, etc.) to perform a second task different from the first task. The model may be used as it is for the second task, or it may be at least partially retrained (also referred to as fine tuning) for the second task. In such embodiments, the parameters of the model learned for the first task are used as a starting point for optimisation for the second task, where some or all of the parameters may be further optimized. The further optimisation may freeze some of the parameters learned in the first task (i.e. they are not changed during optimisation for the second task) and/or apply a lower learning rate such that the optimisation explores a more restricted space around the weights optimised for the first task. For example, the machine learning model may be trained using training data comprising data from a plurality of modalities and causal language modelling, masked language modelling or combined approaches such as causal masked modelling, using commutative modelling as described herein, and transitive modelling, as described herein. The resulting foundation model may then be used directly for any generative task of interest, such as e.g. generating data for one or more modalities of the plurality of modalities using input data from other one or more modalities of the plurality of modalities. Generally, any generative task is possible, generating completion data for one or more modalities of the plurality of modalities using input data comprising incomplete data for any one or more of the plurality of modalities, etc. The resulting foundation model may be fine-tuned for any generative task, such as e.g. by fine tuning any weights of the foundation model using task specific training data (e.g. training data comprising data associated with one or more cohorts of subjects of interest). The resulting foundation model may be used as part of a classification or regression model that additionally includes a classification or regression module, respectively. A classification module refers to any machine learning model that can take as input extracted features from the trained foundation model (the trained commutative and transitive machine learning model) for an input data set and provide an output indicative of the class that the input data set belongs to. For example, in the context of binary classification the output may be a single probability of belonging to one of two classes. In the context of multiclass classification, the output may comprise a plurality of probabilities of belonging to a respective plurality of classes. A classification module may be referred to as “classification head” or “classification layer”, particularly in the context of deep neural networks. A classification layer is typically a single layer of a deep neural network. A classification head can comprise multiple layers. A regression module refers to any machine learning model that can take as input extracted features from the trained foundation model (the trained commutative and transitive machine learning model) for an input data set and provide a continuous output of interest. For example, a regression module can predict a continuous value such as a likelihood of survival over a predetermined period of time, an odds ratio, a predicted response of a patient to a treatment, etc. As a specific example, a regression module may be a survival model, such as a Cox proportional hazards model. A regression module may be referred to as “regression head” or “regression layer”, particularly in the context of deep neural networks. A regression layer is typically a single layer of a deep neural network. A regression head can comprise multiple layers.

Classification refers to the use of a machine learning model to classify input data between two or more categories. For example, speech and/or image and/or text data can be classified between a plurality of categories. A classification method or model may be associated with a level of accuracy evaluated using one or more metrics on one or more test datasets. Any classification accuracy metric known in the art may be used, including e.g. the top-k accuracy (where k can be, e.g. 1, 2 or 3), classification accuracy (% correct predictions) or the F1-score. The top-k accuracy is the number or percentage of times where the correct classification label is in the top k labels predicted, ranked by probability of the class. The F1-score is the harmonic mean of the precision (number of true positive predictions divided by total number of positive predictions-including true positives and false positives) and recall (number of true positive predictions divided by the total number of real positive instances, i.e. the sum of the true positive predictions and the false negative predictions) of a binary classification. In multiclass classification problems, the F1-score is obtained as the average (optionally weighted by class proportions to account for class imbalance) of the F1-score for each class. The classification accuracy is the ratio of the number of correct predictions made for a dataset relative to the number of predictions made. A regression method or model may be associated with a level of accuracy evaluated using one or more metrics on one or more test datasets. Any regression accuracy metric known in the art may be used, including e.g. the c-index (particularly in the case of survival models), mean square error, root mean squared error and mean absolute error. The c-index (concordance index) a generalization of the area under the ROC curve (AUC) that can take into account censored data. The c-index of a survival model represents the model's ability to correctly provide a reliable ranking of the survival times based on the individual risk scores. It is a measure of the probability that the predicted event times for two observations (subjects) have the same relative order as their true event times. The c-index can be calculated as: c−index=Σ_{i,j}1_{T}_{_{j<T}}ᵢ*1_{α}_{ⱼ}_{>α}_{ᵢ}*δⱼ/Σ_{i,j}1_{T}_{ⱼ}_{<T}_{ᵢ}*δⱼ where αᵢ is the risk score for observation i, Tᵢ and Tⱼ are the event times for observations i and j, 1_{T<T}_{ᵢ} is equal to 1 if Tⱼ<Tᵢ and 0 otherwise, and 1_{α}_{ⱼ}_{>α}_{ᵢ} is equal to 1 if αⱼ>αᵢ and 0 otherwise. Values of 1 correspond to the best possible predictions, and values of 0.5 correspond to random predictions. The mean square error (MSE) is the average of the squared differences between predicted and expected (ground truth) values in a dataset. The root mean square error (RMSE) is the square root of the mean square error. The mean absolute error (MAE) is the average of the absolute differences between predicted and expected (ground truth) values in a dataset. The RMSE, MSE and MAE are such that better performing models are associated with lower values of these metrics. A generative sequence model may be associated with a level of accuracy evaluated using one or more metrics on one or more test datasets. Any metric known in the art for evaluating sequence models may be used such as e.g. perplexity. Perplexity is the exponentiated average negative log-likelihood of a sequence. For a tokenised sequence X=(X₀, X₁, . . . , Xₜ), the perplexity of X is

$$PPL ( X ) = exp \{ - \frac{1}{t} {\sum }_{i}^{t} log {p}_{θ} ( {x}_{i} \vert {x}_{0} , .. , {x}_{i - 1} ) \} .$$

Higher perplexities are associated with higher performing models.

Methods of the present disclosure are expected to perform better than comparative models trained on the same multimodal training data and/or with the same computational load. Performance can be evaluated using any metric known in the art depending on the task that the model is configured to perform, such as e.g. as explained above. Methods of the present disclosure are expected to perform better than comparative models for prediction tasks where the input data for the prediction task includes observations for pairs of modalities that are not represented in the training data that was used to train the model, or that are poorly represented in the training data that was used to train the model. Pairs of modalities may be considered to be poorly represented in a training data set when the number of training data pairs comprising data for the pair of modalities is significantly smaller than the number of training data pairs comprising data for any other pair of modalities. For example, the number of training data pairs comprising data for the pair of modalities can be less than 50%, less than 40%, less than 30%, less than 20%, less than 10%, less than 5% or less than 1% of the number of training data pairs comprising data for any other pair of modalities. The benefits associated with the methods of the present disclosure are expected to be present in any such situation, and to increase with lower amounts of training data for any pair of modalities.

Methods of embodiments the present disclosure comprise tokenising data prior to providing the data as input data to a machine learning model. Tokenisation refers to the process of obtaining a representation of data into a predetermined numerical space. The tokenised representation can also be referred to as embeddings. For example, transformer models take a sequence of tokens as input, so when using transformer-based models the data must first be tokenized. There are several ways known in the art to transform data into tokens, and any such known method can be used. For example, data can be transformed into tokens directly using the underlying raw byte stream (as described in e.g. Reed et al. 2022). For example, any of text, nominal, and other discrete data can be encoded using a lookup table (also referred to as a dictionary). Specific examples include the tokenization of text data using Byte Pair Encoding (as in e.g. BERT), SentencePiece (as in e.g. GPT), or WordPiece. As another specific example, raw numerical data can be binned into a predetermined number of bins, each associated with a value, together forming a dictionary of size corresponding to the predetermined number of bins. As another example, any of low-dimensional audio, image, and other continuous data can be encoded by their raw byte values (as in e.g. ImageGPT, Perceiver). For example, each pixel of an image or frequency of an audio file can be used as a single token. High dimensional data can be first dimensionality reduced then tokenised. Dimensionality reduction can be performed by projection into a lower dimensionality space, and/or by splitting the data (e.g. patching). For example, high-dimensional continuous data such as large images or audio can be first patched and tokenized via a codebook or dictionary. A codebook is a vector representation in discrete latent space. A codebook can be obtained from a vector-quantized variational autoencoder (as in e.g. DALLE and MusicLM). Note that a codebook can also be used without prior dimensionality reduction. A dictionary is a lookup tables in which original values in the data are mapped to a predetermined number of values in the dictionary. In embodiments, a codebook is obtained using a learned function that projects input data into a latent space of predetermined dimension d. This may use a plurality of trainable weights that are trained at the same time (or prior to) as the rest of the machine learning model. For example, flattened images or image patches can be linearly projected into a latent space using weights that are trained at the same time as the rest of the model. A patch (also referred to as “tile”) is a subsection of a larger data object, such as an image. A patch may also be referred to as a “tile”. Patches may have predetermined sizes, typically expressed in terms of number of pixels in each of two dimensions in the case of images. Patches may be non-overlapping patches. A flattened image or patch is a data object corresponding to an image in which a two-dimensional matrix comprising values for image pixels is transformed into a one dimensional vector by concatenating rows or columns. Dimensionality reduction by projection into a lower dimensionality space can be performed by applying principal component analysis to a training data set to identify a plurality of principal components, and projecting any input data along a predetermined set of the principal components (e.g. the first 10, 20, 100, 200, 1000 principal components, depending on the desired size of the resulting data).

The methods of the present disclosure find uses in many fields, and especially fields where obtaining or collecting fully aligned multimodal data is difficult or impossible. Fully aligned multimodal data refers to multimodal data where each observation is associated with data for each of the multiple modalities considered (strongly aligned data), and/or significant amounts of aligned pairs of data exist for all possible pairs of data modalities (weakly aligned data). Multimodal data refers to datasets comprising data that is associated with different types of information and/or that has been acquired using different sensors/acquisition means. For example, multimodal data can comprise data obtained from a plurality of sensors that measure different physical, physiological, physico-chemical or biological parameters. As another example, multimodal data can comprise data in the form of images, text, audio, etc. As another example, multimodal data can comprise data from a plurality of modalities selected from: medical images (such as e.g. MRI, CT, or PET imaging data, each such type of imaging data representing a different modality), electronic-medical-record data (e.g. electronic-medical-record representation, text and/or categorical data representing medical history, including one or more of treatment, comorbidities, etc, each of which can represent a different modality), biological sample data (such as e.g. omics data obtained from a sample, or digital pathology imaging data, where every type of omics data or digital pathology imaging data can represent a different modality). Omics data can refer to e.g. genetic sequence data (e.g. a genetic-sequence representation, which can include e.g. the identification of the presence of one or more genetic sequences or variants in a subject or sample from a subject, the presence or expression level of one or more gene expression products in a sample from a subject, etc.). Omics data can be selected from: mRNA expression data (e.g. mRNA sequencing data, gene expression array data, RT-PCR data, digital PCR data, etc.), genomic data (e.g. genome sequencing data such as whole genome sequencing data, whole exome sequencing data, targeted panel sequencing data or data derived therefrom such as e.g. copy number information, variant information, mutational signature information, etc.), epigenetic data (e.g. DNA and/or histone modification data), proteomic data (e.g. data from reverse-phased protein arrays, mass spectrometry, etc.), metabolomics data (e.g. data from any metabolite detection assay, including but not limited to mass spectrometry, targeted detection assays such as glucose or other metabolite detection, etc.). The term “medical image” refers to any digital image of a biological subject. Medical images may be images of a subject or part of a subject. For example, medical images may be radiology images, magnetic resonance imaging (MRI) images, positron emission tomography (PET) images, or ultrasound images. Any imaging technique that is used in a clinical context to make decisions based on morphological features visible in the image may benefit from the methods of the present disclosure. The term digital pathology as used herein encompasses analysis of histopathology images (images of tissues), cytopathology images (images comprising individual cells that are analysed for features of the individual cells), hematopathology images (images of samples of blood or blood cells) or anatomic pathology images (images of organs or tissues at various levels of resolution). A digital pathology image may be an image of a biological specimen that has been fixed and stained with one or more stains. Any staining method known in the art may be used, such as eg. H&E staining (hematoxylin & eosin), immunofluorescence, silver nitrate, Romanowsky Stains-Giemsa Stains, and trichrome stains. Medical images and digital pathology images are commonly analysed in the context of cancer diagnosis, prognosis and treatment, neurodegenerative disease diagnosis, prognosis and treatment, cardiovascular disease diagnosis, prognosis and treatment, etc. The same is true for omics data and electronic health records data. Thus, omics data and/or electronic health records data and/or medical image data and/or digital pathology image data are frequently used alone or in combination with each other to obtain a diagnosis, prognosis, treatment recommendation or patient selection (e.g. for participating in a clinical trial), for many conditions including but not limited to cancer, neurological diseases and cardiovascular diseases. Machine learning approaches to implement these tasks advantageously benefit from reproducibility, reliability, speed and frequently higher accuracy than analysis by trained healthcare professionals. However, machine learning approaches have so far not been proposed that can leverage multimodal data to the extent that is currently done by manual analysis because prior to the present disclosure there was no multimodal machine learning approach designed to specifically deal with training datasets including missing modality pairs. The present disclosure provides a solution that can deal with this, thereby opening new possibilities for multimodal machine learning based predictions in the medical fields. Thus, also described herein are methods of processing input data associated with a subject for the purpose of disease diagnosis, prognosis, monitoring, or therapy identification, the methods comprising processing said input data using models or methods as described herein. A biological sample or specimen may be any sample comprising cells, whether obtained directly from a subject or from a cell or tissue culture. In embodiments, a biological sample is a sample that has been previously obtained from a subject. The sample may be a sample of tissue or bodily fluid (e.g. a biopsy or liquid biopsy).

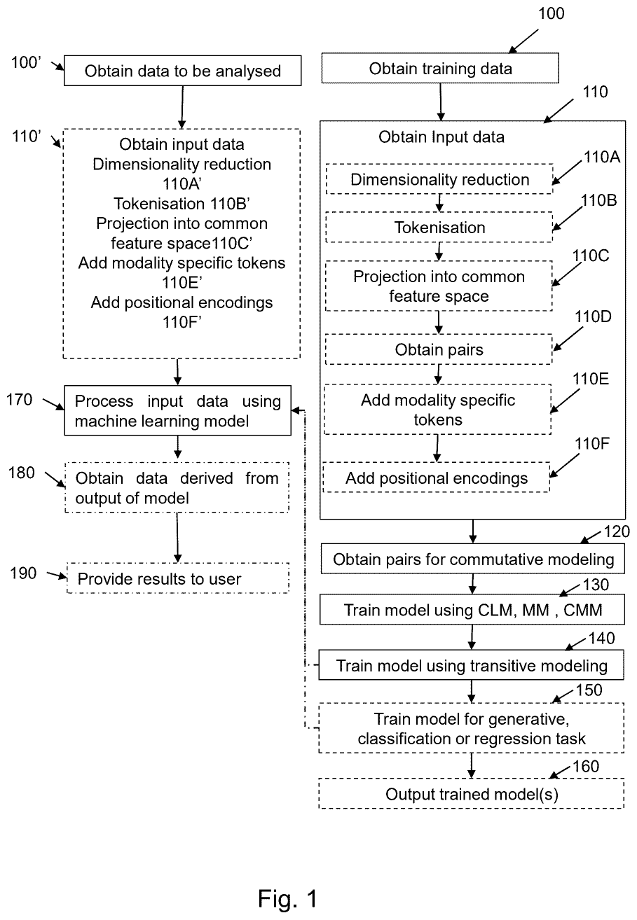

FIG. 1 shows a flow diagram of a method for analysing data using a transitive and commutative machine learning model as described herein and a method for providing training a transitive and commutative machine learning model as described herein.

A method for training a transitive and commutative machine learning model will now be described. At step 100, a training data set is obtained by a processor. Training data may be received from a user interface, database, data store, computing device or data acquisition device(s). All subsequent steps are performed by the processor or a processor communicably coupled to the processor that obtained the training data. The training data comprises data for a set of at least three modalities. Thus, step 100 can comprise accessing a training data set comprising data for each of a set of at least three modalities. The training data may lack data associating first data of a particular input modality with second data of a particular output modality. The training data may comprise or consist of data associating data of pairs of modalities of the set of at least three modalities, wherein for each pair of a first and second modality of the set of at least three modalities, the training data comprised data associating data of pairs of modalities that together form a path between the first and second modality. In embodiments, for each pair of a first and second modality of the set of at least three modalities, the training data comprises data associating data of the first modality with a third modality and data associating data of the third modality with the second modality. Thus, the training data may not include training data that associates any pair of modalities but may include data that associates the modalities in the missing pair using one or more bridging (also referred to herein as “linking”) modalities. The training data can comprise or consist of tuples (e.g. pairs) comprising corresponding data for multiple modalities of the set of at least three modalities, wherein the tuples including data for a specific pair of modalities of the set of at least three modalities were present in the training data at less than 50%, less than 40%, less than 30%, less than 20%, less than 10%, less than 5% or less than 1% of the number of tuples including data for all other pairs of modalities of the set of at least three modalities. In embodiments, the tuples did not comprise tuples that include data for a specific pair of modalities of the set of at least three modalities (i.e. one pair of modalities is completely or substantially missing from the training data).

The three or more modalities can be selected from medical or biological sample data associated with a subject. For example, the one or more modalities can be selected from: medical image data, electronic-medical-record data, genetic sequence data, and digital pathology image data, optionally wherein medical image data is selected from MRI, CT or PET imaging data.

At step 110, the training data is used to obtain input data for the machine learning model. This may comprise one or more of the following optional steps. At step 110A, data for one or more modalities in the training data may be dimensionality reduced, for example using PCA. At step 110B, data for each modality in the training data may be individually tokenised using a respective predetermined tokenisation scheme. At step 110C, the tokenised data obtained at step 110B may be projected into a common feature space across modalities. This may use a parameterised embedding function. At step 110D, pairs of input data may be generated each comprising data first data for a first modality and associated second data for a second modality. Note that the training data may include data (also referred to as “tuples”) that associates more than two different modalities (i.e. data for more than two modalities for the same subject or object). In such cases, it will be possible to sample multiple pairs from the same tuple, at step 110D. At step 110E, one or more modality specific tokens may be added to the pairs obtained at step 110D to indicate the start and/or end of a modality. At step 110F, modality-specific absolute positional encodings can be added to the feature vectors obtained at step 110D or 110E. This may be learned at the same time as the weights of the model.

Training of the model uses pairs obtained from the training data that comprise first data for a first modality and associated second data for a second modality. Prior to providing multimodal pairs (e.g. pairs obtained at steps 110D, 110E or 110F) as input to the model for training, the order of the two modalities in each pair may be randomly sampled between a first order and a second order. Alternatively, pairs corresponding to both orders may be generated. This is referred to as commutative modelling, performed at step 120. Thus, step 120 can comprise generating training ground truth data from the training data set, the ground truth data comprising, for each of a plurality of data pairs in the training data, concatenated input data for a first modality and a second modality of a data pair, wherein the modality of the data pair used as the first modality is randomly sampled from the two modalities of the data pair with a predetermined probability. The predetermined probability can be a 50% probability. It allows the model to infer a first modality from a second modality and the second modality from the first modality, at step 130. Thus, the model may be trained in a first step 120-130 in which the model is trained using commutative modeling and a self-supervised learning objective.

At step 130, the pairs can be used to train the model using causal language modeling (CLM), masked modeling (MM), and/or any variant thereof such as causal masked modeling (CMM), prefix language modeling [PLM, Raffel et al. 2019], permutation modeling [Yang et al. 2020], unified language learning [uniLM, Dong et al., 2019; UL2/mixture of denoisers, Tay et al. 2023], LLM2Vec [BehnamGhader et al., 2024], and GIVT-Causal/GIVT-MaskGIT [Tschannen et al. 2024]. Thus, step 130 can comprise training the model to take as input a partially masked concatenated input data for a first modality and a second modality of a data pair in a training data set comprising ground truth data for a plurality of data pairs each comprising corresponding data for a pair of modalities, and produce as output a prediction of the masked input data, wherein the modality of the data pair used as the first modality was randomly sampled from the two modalities of the data pair and/or the ground truth data comprised for each of the plurality of data pairs in the training data first concatenated input data and second concatenated input data wherein the modality of the data pair used as the first modality is different between the first concatenated input data and second concatenated input data.

In embodiments, such as e.g. as illustrated in the examples below, the model is trained a step 130 using causal masked modeling (CMM). At this step, the model is trained to learning the conditional distribution of any pairs of modalities present in the training data. The causal generative modelling, masked modeling, and/or variation thereof may use ground truth data that comprises, for each of a plurality of data pairs in the training data, concatenated input data for a first modality and a second modality of a data pair. The modality of the data pair used as the first modality can be randomly sampled from the two modalities of the data pair. Alternatively, the ground truth data can comprise for each of the plurality of data pairs in the training data first concatenated input data and second concatenated input data wherein the modality of the data pair used as the first modality is different between the first concatenated input data and second concatenated input data, either of these options ensure commutativity when training the model using a self-supervised objective such as causal language modeling (CLM), masked modeling (MM), and/or variants thereof. Causal masked modeling can comprise: identifying a subset of tokens in a training data set, wherein the tokens in subset of tokens are at multiple positions within the training data set; appending the training data set with the subset of tokens; and adding masks at the multiple positions within the training data set. The causal masked modeling can further comprise using an identification of the multiple masked positions during the training.

At step 140, the model is further trained using transitive modeling. The weights of the model at step 140 may be initialized to weights learned at a first step 120-130 that uses commutative modeling, and further trained using transitive modeling at step 140. Alternatively, training using commutative modeling and transitive modeling may be combined. Training using transitive modelling can comprise training the model using transitive modeling can comprise training the model to, for each of a plurality of data pairs of a training dataset, each comprising first data for a first modality and corresponding second data for a second modality of the set of at least three modalities: predicting third data for a third modality of the set of at least three modalities corresponding to the second data using the machine-learning model taking as input the second data; predicting final data for the first modality corresponding to the predicted third data using the transitive and commutative machine-learning model taking as input the third data; and computing a loss that compares the first data and the predicted final data. In such embodiments the training data can comprise: (i) pairs comprising data for the second modality and corresponding data for the third modality, and (ii) pairs comprising data for the third modality and corresponding data for the first modality. Training the model using transitive modeling can comprise training the model to, for each of a plurality of data pairs of a training dataset, each comprising first data for a first modality and corresponding second data for a second modality of the set of at least three modalities: predicting third data for a third modality of the set of at least three modalities corresponding to the second data using the machine-learning model taking as input the second data; iteratively predicting subsequent data for a further modality of the set of at least three modalities corresponding to the predicted third data or predicted subsequent data using the transitive and commutative machine-learning model taking as input the predicted third data or predicted subsequent data; predicting final data for the first modality corresponding to the predicted latest iteratively predicted subsequent data using the transitive and commutative machine-learning model taking as input the latest iteratively predicted subsequent data; and computing a loss that compares the first data and the predicted final data. In such embodiments, the training data can comprise: (i) pairs comprising data for the second modality and corresponding data for the third modality, and (ii) pairs comprising data for the latest further modality and corresponding data for the first modality and respective pairs comprising data for each of the two modalities used in the step of iteratively predicting subsequent data for a further modality. In other words, the method may comprise at step 100 accessing a training data set that includes first data of a particular input modality and corresponding second data of another modality; and at step 140 generating a first predicted output data set by processing the first data and an identification of the other modality using the transitive and commutative machine-learning model, wherein the first predicted output data set corresponds to the other modality; generating a second predicted output data set by processing the first predicted output data and an identification of the particular target output modality using the transitive and commutative machine-learning model, wherein the second predicted output data set corresponds to the particular target output modality; generating a third predicted output data set by processing the second predicted output data and an identification of the particular input modality using the transitive and commutative machine-learning model, wherein the third predicted output data set corresponds to the particular input modality; and computing a loss by comparing at least part of the third predicted output data set to the first data.

The trained model resulting from step 140 is a transitive and commutative machine-learning model in that it is a machine learning model that has been trained to transform input data sets corresponding to any and each of the modalities of the set of least three modalities to output data sets of any and each other of the modalities of the set of at least three modalities, wherein the machine learning model has been trained to transform data between two modalities by using training data that includes data pairs corresponding to a first of the two modalities and another modality and other data pairs corresponding to the other modality and a second of the two modalities, and the machine learning model has been trained to perform a corresponding reverse type of modality transformation for any forward type of modality transformation that the model has been trained to perform. Steps 130 and 140 together may also be described as training the machine-learning model to learn a first conditional distribution (P(C|A), P(A|C)) of a pair of modalities (A, C) for which the training data did not contain sufficient training data pairs associating data of the pair of modalities to parameterise the conditional distribution, by predicting data for one or more additional modalities (B) forming a link between the pair of modalities using learned further conditional distributions (P(C|B)) of pairs of modalities (C, B) forming said link and for which the training data did contain sufficient training data pairs associating data of the pair of modalities to parameterise the further conditional distributions.

The trained model resulting from step 140 may be considered to be a final trained model for use on an input data set, such as e.g. for a generative task such as infilling or translation between modalities. Alternatively, the model may be further trained at step 150 for a different generative task, and/or included as part of a classification or regression model that is trained at step 150. A classification model may be a model that comprises the model obtained at step 140 (transitive and commutative machine-learning model), and a classification model that is trained at step 150 to take as input extracted features from the transitive and commutative machine-learning model and produce as output a classification for the input dataset provided to the transitive and commutative machine-learning model. A classification model can be trained at step 150 using training data comprising data for one or more of the set of at least three modalities and associated ground truth classification labels. A generative model can be a model comprising or consisting of the trained machine learning model obtained at step 140, that is further trained at step 150 to take as input an input dataset and produce as output a generated output data set corresponding to the input data set, wherein the output data set corresponds to a modality of the set of at least three modalities that is not present in the input dataset. In other words, the generative model can be trained to take as input an input dataset and produce as output a generated output data set corresponding to the input data set, wherein the output data set corresponds to a modality of the set of at least three modalities that is not present in the input dataset. Instead or in addition to this, the generative model can be trained to take as input an input dataset comprising missing data and produce as output a generated output data set corresponding to the missing data in the input data set. The trained machine learning model obtained at step 140 can be used for this as the generative model or the trained machine learning model obtained at step 140 can be fine-tuned at step 150 using further training data to obtain the generative model. A regression model can be a model that comprises the model obtained at step 140 (transitive and commutative machine-learning model), and a regression model trained at step 150 to take as input extracted features from the transitive and commutative machine-learning model and produce as output a regression value for the input dataset. The regression model can be a Cox Proportional-Hazards Model and the regression value can be a survival prediction. Alternatively, the regression value can be any continuous value associated with the input data, for example a probability (e.g. probability of having or developing a disease, probability of responding to a therapy, etc.). The regression model can be trained at step 150 using training data comprising data for one or more of the set of at least three modalities and associated ground truth regression values.

For example, the machine learning model can be trained at step 150 to take as input medical or biological sample data associated with a subject and produce as output an indication of a treatment that is recommended for the subject. The indication can be a classification. The medical or biological sample data can comprise one or more of: as radiological images, genetic sequences, and microscopic slides. As another example, the machine learning model can be trained at steps 130-140 and optionally further at step 150 to take as input data collected by any one or more of multiple types of sensors associated with a vehicle, optionally an automobile, and to generate as output predicted sensor data for another type of sensor data associated with the vehicle, optionally wherein the machine learning model has been trained using synchronized data from pairs of the multiple types of sensors.

At optional step 160, one or more machine learning models or any parameters thereof obtained as a result of steps 140 or 150′ are provided to a user or computing device.

Training of the machine learning model applies commutative modeling. We ensure commutativity by randomly mixing the order of concatenation when appending tokens from two modalities to an input sequence as described above. This allows the model to infer modality A from B and modality B from A. The random mix is performed by randomly inverting the default order of providing modalities as input to the machine learning model, using a predetermined probability. In a fully commutative model, the probability can be 50%, meaning that a pair of inputs A and B is as likely to be presented as (A,B) or (B, A). This probability can be set to a value that is different from 50% (e.g. below 50%) to prioritise learning in a predetermined direction. This may be useful in some circumstances, for example depending on the task that the model is intended to be trained for, and the combination of modalities intended to be used when testing and/or deploying the model. In embodiments, commutative modeling is used to pretrained the model using a self-supervised learning objective. The self-supervised learning objective may be a causal generative modeling objective. Thus, the model may be trained using commutative modeling in the context of a self-supervised learning task such as causal generative modeling. The causal generative modeling may include one or more of: causal language modeling, masked language modeling, and derivatives thereof.

Training of the machine learning model applies transitive modeling. Consider an example in which 3 modalities A, B, C are modelled, where only the combinations (A, B) and (B, C) exist in the training data. Training of the machine learning model can be performed by randomly sampling a pair available in the training data (e.g. (a, b), (b, a), (b, c), or (c, b)) during training and apply transitive modeling. Transitive modeling comprises predicting missing modalities of a multimodal dataset by inferring any missing data points needed to transition between two modalities using learned relationships between modalities for which pairs of data are available (also referred to herein as bridging or linking modalities, in the above example, B is a linking modality between modalities A and C). For example, consider the pair (a, b). Since the model is trained to predict modality C from B, it is possible to infer a pseudo data point c (i.e. predict a value for c, even though no ground truth data is available for a value c corresponding to data a) from b. Since the model can also predict modality A from C, the new sample c (pseudo data point) is used to predict point a again, ensuring that all modalities are aligned. The same principle can be applied to the pair (b, a), where a pseudo data point c can be inferred from a, which can then be used to predict point b, where the loss between the predicted point b and the ground truth point b is minimized, said loss being associated with the prediction of pseudo data point c from point a and the prediction of b from the pseudo data point C.

In embodiments, obtaining or generating the input data at step 110 can comprise generating the input data set by tokenizing the initial data set (step 110B). In embodiments, obtaining or generating the input data at step 110 can comprise tokenizing the initial data set (step 110B) and projecting the tokenised initial data set (step 110C) into a predetermined feature space using a parameterized embedding function for each modality. A parameterised embedding function refers to a function with learned parameters. This can be implemented as one or more additional layers of the deep learning model, the parameters of which are learned when training the deep learning model. In embodiments, obtaining or generating the input data at step 110 can comprise at step 110E generating the input data set by prepending and/or appending a modality specific token to the tokenised and optionally projected data corresponding to each single modality in the input data set. In embodiments, obtaining or generating the input data at step 110 can comprise including learned positional embeddings at step 110F. Learned positional embeddings are positional embeddings that are learned at the same time as training the machine learning model.

In an embodiment, all input data is tokenised using a chosen predetermined scheme. After tokenization, a parameterized embedding function is used to project all tokens into a common feature space (e.g. tokenised representations of samples a, b, c of modalities A, B, and C are projected into a shared vector space: a->[a_1, . . . , a_l], b->[b_1, . . . , b_m], and c->[c_1, . . . , c_n]). In embodiments, the embedding function is implemented as a linear layer with parameters learned together with the other parameters of the model (i.e. the weights of all layers including the embedding layers are learned together). This is advantageously simple. Alternative implementations of the parameterised embedding function include a convolutional layer or a plurality of layers (i.e. an additional neural network for embedding), such as e.g. a transformer block. Such implementations typically include more parameters to train, but may be beneficial in some circumstances depending on the complexity of the input data. Further, modality-specific tokens are added to indicate the start and end of a modality. In embodiments, learned modality-specific absolute positional encodings are added to the feature vectors. The embeddings for each modality are then concatenated when they are aligned (e.g. if a and b are aligned, then the input to the model would be s=[a_1, . . . , a_l; b_1, . . . , b_m] or s=[b_1, . . . , b_m; a_1, . . . , a_l] where the use of both orders ensures commutativity). For example, for an audio-image pair or an image-text pair describing the same concept, their token sequences can be concatenated and fed them into the model (e.g. transformer model). However, if only one modality is available, then the token sequence for that modality alone is used as input to the model.

In embodiments, the model is trained using causal generative modelling. Causal generative modelling refers to the task of predicting the next token in a sequence given the sequence of past tokens. This can be expressed as given a sequence of tokens s_1:L and parameters θ, as modeling the data using the chain rule of probability: log pθ(s1, . . . , sL)=sum log pθ(sl|s1, . . . , sl−1). As explained above, commutativity can be ensured in this framework by randomly mixing the order of concatenation when appending tokens from two modalities to form an input sequence. This allows the model to infer modality A from B and modality B from A. This is referred to herein as commutative modeling.

In embodiments, training the model using causal generative modeling uses causal masked modeling. Causal masked modeling randomly masks out a span (or many spans) of tokens and moves them to the end. This allows the model to still use the information after the mask to predict the masked positions, which is not possible with classical generative modeling. This is not necessary for performance of the models described herein, but is advantageous. Indeed, models such as generative pre-trained transformers only consider information from the left and ignore information from the right, they are known to lack bidirectional context, which is important for many downstream tasks. The use of causal masked modeling enables to train a universal model that can be fine-tuned for many different downstream tasks. Other approaches that unify masked modeling and causal modeling can also be used, such as e.g. prefix language modeling (PLM), permutation modeling, unified language learning, LLM2Vec, and GIVT-Causal/GIVT-MaskGIT. The latter is associated with a specific architecture (Generative Infinite-Vocabulary Transformer, GIVT), whereas the other approaches are generally applicable to decoder only language models.

In embodiments, the machine-learning model may be trained to prioritize each of commutative and/or transitive processing. Such training may include configuring input to the machine-learning model to identify a particular target output modality (e.g., as it may be possible to transform any given input to outputs of multiple output modalities). The training may further or alternatively include defining a training technique and/or loss function (e.g., a cross-entropy loss function) to relate and/or prioritize transforming data bi-directionally and/or across three or more types of data.

In embodiments, the machine learning model may be pretrained using commutative modeling on a self-supervised learning objective (e.g. causal language modeling, masked language modeling and/or derivatives thereof as explained further herein), but without using transitive modeling. This may use available pairs of linked data modalities. The resulting pretrained model may then be used as a starting point for further training using transitive modeling. In other words, the machine learning model may be pretrained using a first step using commutative modeling and a self-supervised learning objective, and a second step in which the machine learning model weights are initialized to the weights learned in the first step and further trained using transitive modeling.

A method for analysing data will now be described. At step 100′, data for which a prediction is to be made is obtained by a processor. The data set obtained comprises data from one or more modalities selected from a set of at least three modalities. The set of at least three modalities corresponds to the set of at least three modalities that the machine learning model used at step 170 below has been trained to process. Step 100′ may comprise receiving data associated with one or more modalities. Step 100′ may comprise obtaining or accessing input data (such as e.g. medical data or biological sample data) by a processor receiving the input data from a database, data acquisition means (e.g. medical data mage acquisition means, biological sample data acquisition means such as a microscope, sequencer or computing device associated therewith), computer readable medium, user interface or computing device. This may comprise receiving data from a user interface, database, data store, computing device or data acquisition device. All subsequent steps are performed by the processor or a processor communicably coupled to the processor that obtained the data. At optional step 110′, the data is processed to obtain an input data for a trained machine learning model as described herein. Step 110′ may comprise one or more of: dimensionality reduction at step 110A′, tokenisation at step 110B′, projection into a common feature space at step 110C′, addition of modality specific tokens at step 110E′, and addition of positional encodings at step 110F′. Any of these steps may be performed as explained above in relation to steps 110A, 110B, 110C, 110E and 110F.

At step 170, the input data is processed using a trained machine learning model as described herein, e.g. as obtained at step 140 or step 150. Thus, step 170 may comprise generating an output data set by processing the input data set using a machine learning model comprising a transitive and commutative machine-learning model, wherein a transitive and commutative machine-learning model is a machine learning model that has been trained to transform input data sets corresponding to any and each of the modalities of the set of least three modalities to output data sets of any and each other of the modalities of the set of at least three modalities, wherein the machine learning model has been trained to transform data between two modalities by using training data that includes data pairs corresponding to a first of the two modalities and another modality and other data pairs corresponding to the other modality and a second of the two modalities, and the machine learning model has been trained to perform a corresponding reverse type of modality transformation for any forward type of modality transformation that the model has been trained to perform. At optional step 180, derived data may be obtained from the output of the machine learning model, such as e.g. a prognosis indication, treatment selection, diagnosis indication, selection for participating in a clinical trial, etc. This step is optional and the output of the machine learning model obtained at step 170 may already be directly interpretable as one of these types of information. At step 190, the results of any one or more of the preceding steps are provided to a user, for example through a user interface. For example, results may include a classification prediction, a regression prediction, a predicted output data associated with one or more of the plurality of modalities (e.g. output of a generative model), one or more trained parameters of the trained machine learning model, the trained machine learning model, and/or any information derived therefrom. A data store may be a public or private database. Information derived from a classification prediction may comprise one or more of: a prognostic indication derived from a classification obtained using the machine learning model, a therapeutic indication derived from a classification obtained using the machine learning model, an indication of suitability for taking part in a clinical trial derived from a classification obtained using the machine learning models, etc.

The trained machine learning model may be used to generate an output data set of a particular target output modality using an input data set of one or more other modalities. Thus, step 100′ can comprise determining a particular input modality of the input data set, and receiving an indication of a particular target output modality. Step 170 can comprise generating an output data set by processing the input data set and the identification of the particular target output modality using the transitive and commutative machine-learning model.

In embodiments, as previously described, a machine learning model may be trained and/or used to transform data between modalities. Thus, the model may be used to identify an output of a particular target output modality using an input data set of a (other) particular input modality. Once the output of the particular target output modality is identified, the output may be output (e.g., transmitted to another device or presented via an interface), the output may trigger or may be used to identify an action (e.g., a movement of a prosthetic arm or a driving control in an automobile), and/or the output may be used to generate another result (e.g., that may be output, that may trigger another action, or that may be used to identify another action). As one example, a particular target output modality may include a predicted MRI scan, which may then be post-processed to identify a potential diagnosis. A result may be generated to include the potential diagnosis, the predicted MRI scan, and one or more potential treatments (e.g., determined based on the potential diagnosis). The result can be transmitted to a device of a care provider.

Collecting a multimodal dataset with two paired modalities A and B or B and C is difficult in practice. Obtaining datasets with three aligned modalities A, B, and C is even more challenging. In healthcare, for example, we sometimes have only genetic sequences and microscopic images for one patient, and only genetic sequences and radiological images for another. This makes it difficult to integrate and combine all modalities into a large pre-trained model. The present disclosure provides a solution to this under-explored problem. Embodiments of the disclosure make use of a self-supervised framework combining causal generative pre-training with the rules of commutativity and transitivity to transition between different modalities. Thus, the proposed solution can learn the relation A→C using A→B→C, in a contact where the training data only contains aligned data for pairs (A,B) and (B, C) but no (or not much, e.g. much less than for the other two pairs) aligned data for pairs (A, C). In particular, the proposed approach can link modalities and transition between them using generative pre-training, commutativity (A, B)=(B, A), and the transitive relation (A→B)∧(B→C)⇒(A→C). Given a dataset containing only the combination (A, B) and (B, C), the present inventors showed that a transformer pre-trained with the new proposed approach can handle any modality combination at inference time after fine-tuning on a downstream task, including the never-seen pair (A, C) and the triplet (A, B, C) while matching the performance of an oracle model. By learning the relationship within and between tokens from different data distributions, the present inventors demonstrated in the Examples below that the approach is able to serve as a general and multimodal feature extractor. This has far-reaching implications for safety-critical domains such as healthcare, infrastructure, and transportation. In medicine, for example, it is already difficult to obtain a large dataset with a single modality to train powerful foundation models-such as those used in computer vision and natural language processing. Finding a dataset with two or more modalities is even more challenging. But combining them is important as it is common practice to look at different types of data, such as radiological images, genetic sequences, and surgical samples, to determine the optimal treatment.

Adding or combining different modalities during pre-training opens up three possibilities: positive transfer, cross-modal comprehension, and cross-modal generation. Positive transfer occurs when learning in one modality helps to improve performance in another modality. For example, it has been shown that aligning images with text can lead to better classification performance on ImageNet (see e.g. CLIP, SimVLM). Cross-modal understanding refers to the explanation of one modality using the other. For example, it is possible to describe an image using text (see e.g. Flamingo) or to understand proteins from sequences (see e.g. AlphaFold). And with cross-modal generation, one can generate one modality using the other. Examples are text-to-image generation (e.g. DALLE-2) and text-to-music generation (e.g. MusicLM). All of these models are based on either contrastive learning (e.g. ALIGN, CLIP, FLORENCE), masked modeling (e.g. VisualBERT, VILBERT, Pixel-BERT, ImageBERT, VL-BERT, VD-BERT, LXMERT, UNITER, VinVL, BeiT-3), or causal modeling (e.g. SimVLM, Flamingo, Gato, DaVinci, CM3, DALLE-1, Parti, Pali, GPT-4). The present disclosure provides a new approach to train models that can perform each of these types of tasks. The present approaches can unify existing methods in masked and causal modeling into a general self-supervised framework. The models trained as described herein can then handle different types of modality combinations in various downstream tasks such as classification. In contrast to previous contributions, which only consider randomly missing modalities, the present methods are designed to be able to deal with situations where entire data pairs are always missing. This creates a powerful model that can be configured and trained to predict many types of data or perform any other type of generative task of interest, or handle any different types of modality combinations in various downstream tasks including but not limited to classification and regression or similar tasks such as e.g. survival prediction.

To illustrate the types of modality transformations that may be supported by using a transitive and commutative machine-learning model (configured and trained in accordance with various embodiments disclosed herein), the following exemplary use cases are provided. In embodiments, a machine learning model as described herein (i.e. a transitive and commutative machine-learning model) is configured to receive a flattened and tokenized version of any of an MRI scan, a PET scan, or a CT scan and to generate any other of the three types of scans. The machine-learning model may be trained with pairs of MRI/CT scans and with pairs of CT/PET scans. Once trained, one potential use of the model is to transform an input MRI scan into a predicted PET scan or the converse, even though obtaining concurrent scans of these types is not possible. In embodiments, a machine learning model as described herein (i.e. a transitive and commutative machine-learning model) is configured to receive embedded data collected by any of multiple types of sensors (e.g., a camera, a sonar sensor, a lidar sensor, etc.) that are in or on an automobile. Pairs of data are generated by synchronizing the sensor readings. Once trained, one potential use of the model is to receive input corresponding to one type of sensor data and to then generate each other type of sensor data; another potential use of the model is to receive input corresponding to two types of sensor data (e.g., concatenated together) and to then generate another type of sensor data. These uses can result in three or more synchronized sensor data sets. Importantly, traditional signal synchronization is error-prone, and the more synchronizations that are performed, the higher the cumulative errors. Therefore, reducing the need for synchronizations by instead using the transitive and commutative machine-learning model, can actually produce more accurate and rich data sets (and reduce the number of sensors needed in vehicles). In embodiments, a machine learning model as described herein (i.e. a transitive and commutative machine-learning model) is configured to receive embedded data collected by any of multiple types of sensors (e.g., a camera, an accelerometer detecting motion to a part of a user's body, an EMG electrode detecting muscle contraction, etc.). Pairs of data are generated by synchronizing the sensor readings. Once trained, one potential use of the model is to receive input corresponding to one type of sensor data and to then generate each other type of sensor data; another potential use of the model is to receive input corresponding to two types of sensor data (e.g., concatenated together) and to then generate another type of sensor data. These uses can result in three or more synchronized sensor data sets. As noted in the above example, traditional signal synchronization is error-prone, and the more synchronizations that are performed, the higher the cumulative errors. Therefore, reducing the need for synchronizations by instead using the transitive and commutative machine-learning model, can actually produce more accurate and rich data sets (and reduce the number of sensors needed to generate signals to limbs).

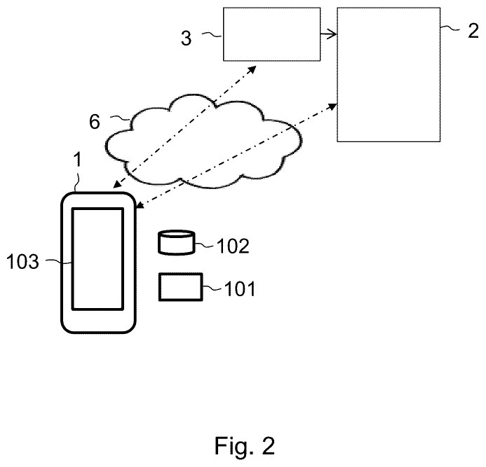

FIG. 2 shows an embodiment of a system for analysing data and/or for providing a trained machine learning model, according to the present disclosure. The system comprises a computing device 1, which comprises a processor 101 and computer readable memory 102. In the embodiment shown, the computing device 1 also comprises a user interface 103, which is illustrated as a screen but may include any other means of conveying information to a user such as e.g. through audible or visual signals. The computing device 1 is communicably connected, such as e.g. through a network, to data acquisition means 3 (such as e.g. medical image data acquisition means and/or omics data acquisition means and/or medical data acquisition means), such as a microscope associated with a histopathology station, a medical imaging device such as MRI or PET scanner, etc. or computing device associated therewith, and/or to one or more databases or data stores 2 storing data such as e.g. medical data. The one or more databases 2 may further store one or more of: one or more deep learning algorithm, training data, parameters (such as e.g. parameters of a deep learning model used to analyse data), clinical and/or sample related information, etc. The data acquisition means 3 can be configured to acquire medical image data, omics data, or any other type of medical data from a patient or specimen. The computing device may be a smartphone, tablet, server, personal computer or other computing device. The computing device is configured to implement a method for analysing data and/or a method for training a machine learning model, as described herein. In alternative embodiments, the computing device 1 is configured to communicate with a remote computing device (not shown), which is itself configured to implement a method as described herein. In such cases, the remote computing device may also be configured to send the result of the method to the computing device. Communication between the computing device 1 and the remote computing device may be through a wired or wireless connection, and may occur over a local or public network 6 such as e.g. over the public internet. The data acquisition means 3 and/or data stores 2 may be in wired connection with the computing device 1, or may be able to communicate through a wireless connection, such as e.g. through WiFi and/or over the public internet, as illustrated. The connection between the computing device 1 and the data acquisition means 3 and/or data stores 2 may be direct or indirect (such as e.g. through a remote computer).

The following is presented by way of example and is not to be construed as a limitation to the scope of the claims.

### Examples

Training multimodal foundation models is challenging due to the limited availability of multimodal datasets. While many public datasets pair images with text, few combine images with audio or text with audio. Even rarer are datasets that align all three modalities at once. Critical domains such as healthcare, infrastructure, or transportation are particularly affected by missing modalities. This makes it difficult to integrate all modalities into a large pre-trained neural network that can be used out-of-the-box or fine-tuned for different downstream tasks. The present examples introduce LoReTTa (Linking mOdalities with a tRansitive and commutativE pre-Training sTrAtegy) to address this understudied problem. The described self-supervised framework unifies causal modeling and masked modeling with the rules of commutativity and transitivity. This allows the approach to transition within and between modalities. As a result, the pre-trained models are better at exploring the true underlying joint probability distribution. Given a dataset containing only the disjoint combinations (A,B) and (B,C), LoReTTa can model the relation A↔C with A↔B↔C. In particular, the present examples show that a transformer pre-trained with LoReTTa can handle any mixture of modalities at inference time, including the never-seen pair (A,C) and the triplet (A,B,C). The present examples extensively evaluate the new approach on a synthetic, medical, and reinforcement learning dataset. Across different domains, the new universal multimodal transformer consistently outperforms strong baselines such as GPT, BERT, and CLIP on tasks involving the missing modality tuple.

### Methods

Model Architecture. The LoReTTa implementation used in the present examples uses the autoregressive transformer decoder architecture described in Radford et al. [2019], with some modifications as described below. This model includes a modified initialization, pre-normalization, and GELU activation. The inventors chose to use RMSNorm [Zhang et al. 2019] rather than LayerNorm [Ba et al. 2016]. They also replaced the StandardAttention [Vaswani et al. 2017] with FlashAttention [Dao et al. 2022] to reduce memory usage and runtime. Following Chowdhery et al. [Chowdhery et al. 2022], the model was trained without dropout and did not use biases in any of the dense kernels or layer norms. While any general sequence model can work for next token prediction, the inventors chose the transformer [Vaswani et al. 2017] in particular for its simplicity and scalability. Theoretically, however, the method also works with other backbones, such as the recently proposed RWKV (Peng et al. 2023) and Hyena (Poli et al. 2023).

Data representation. Since transformers take a sequence of tokens as input, the input data needs to be tokenized. The present examples use common methods such as raw byte encoding [Reed et al. 2022, Jaegle et al. 2021, Chen et al. 2020], learned lookup tables [Kudo and Richardson, 2018, Sennrich et al. 2016, Schuster and Nakajima, 2012], and vector quantization [Van Den Oord et al. 2017, Razavi et al. 2019, Ramesh et al. 2021, Agostinelli et al. 2023]. After tokenization, a parameterized embedding function (here implemented as a simple linear layer with learned parameters) is used to project all tokens into a common feature space. In addition, modality-specific tokens are added to indicate the beginning and end of a modality. Modality-specific absolute position encodings are added to the feature vectors and learned. The representations for each modality are then concatenated, but only if they belong to the same object/subject. For example, if we have an image-audio pair or an image-text pair describing the same concept, we would concatenate their token sequences and feed them into the transformer. However, if only one modality is available, we use only that modality. In summary, the pre-processing step used in the present examples is described below.
1. Tokenize and project all samples a, b, c into a common vector space, obtaining the token embeddings [a₁, . . . , aᵢ], [b₁, . . . , bₘ], and [c₁, . . . , cₙ].
2. If a and b are aligned (i.e. they relate to the same object/subject), concatenate them as s=[a₁, . . . , aₗ; b₁, . . . , bₘ] or s=[b₁, . . . , bₘ; a₁, . . . , aₗ], which ensures commutativity.

Pretraining strategy. The transformer models were trained using causal language modeling (CLM). Given a sequence of tokens S_{1:L} and parameters θ, the data is modeled using the chain rule of probability given by Equation (1):

$$log {p}_{θ} ( {s}_{1} , ... , {s}_{L} ) = {\sum }_{l = 1}^{L} log {p}_{θ} ( {s}_{l} \vert {s}_{1} , ... , {s}_{l - 1} ) \qquad Equation ( 1 )$$

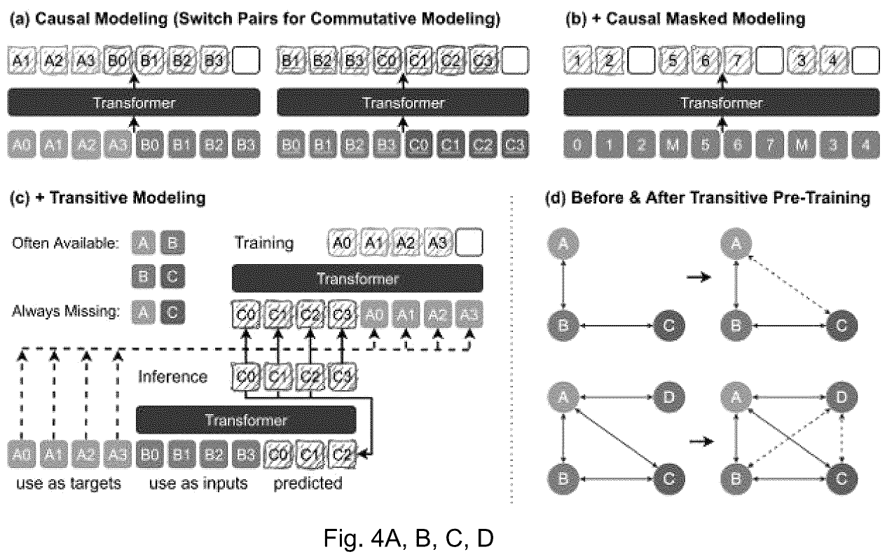

Thus, the task of the model is to predict the next token given the sequence of previous tokens. As shown in GATO [Reed et al. 2022] and PALM-E [Driess et al. 2023], this objective is modality agnostic. The systems even learn rich internal world models [Lin et al. 2023, Li et al. 2023]. Compared to the conventional CLM approach, the inventors ensured commutativity by randomly mixing the order of concatenation when appending tokens from two modalities to an input sequence (step 2 of the pre-processing method described in section “Data representation”), as illustrated on FIG. 4a. This allows the model to infer modality A from B and modality B from A. The inventors called this technique commutative modeling. Interestingly, this simple modification has not been used in recent multimodal foundation models.

Since generative pre-trained transformers only consider information from the left and ignore information from the right, they are known to lack bidirectional context [Wang et al. 2022], which is crucial for many downstream tasks. Thus, the inventors combine masked modeling (GPT-style models) and causal modeling (BERT-style models) into one framework. This recently developed approach is known in the literature under different names: fill-in-the-middle (FIM) [Bavarian et al. 2022], causal masked modeling (CM3) [Aghajanyan et al. 2022, Fried et al. 2023], hybrid unidirectional modeling (HybUni) [Artetxe et al. 2022], span corruption+language modeling (SCLM) [Tay et al. 2022]. All of these approaches are conceptually identical, differing only by minor implementation details. Thus, the reference to causal masked modeling throughout this disclosure encompasses any of the above implementations and any other implementation of the same concept Conceptually, the idea is to randomly mask out a span (or spans) of tokens, replace them with sentinel tokens, and move the original tokens to the end (illustrated on FIG. 4b). This change does not alter the training process based on Equation (1); however, it now allows the model to use the information to the right of the mask to predict the masked positions, which is not possible with traditional unidirectional causal modeling. The hybrid view not only leads to better performance in downstream tasks after fine-tuning but also retains the utility of language modeling. With CM3Leon [Yu et al. 2023], causal masked modeling has been scaled up to large vision-language models capable of generating and filling both text and images. CM3Leon was trained on much more data than CM3 and with a larger transformer, but uses the same algorithm a CM3.

Transitive modeling. The inventors then extend several language learning paradigms (masked, prefix, causal, causal masked) with a new technique, which they call transitive modeling. The problem set out above of enabling learning in contexts in which a combination is unconditionally missing requires to combine modalities A and C, given only the disjoint combinations (A, B) and (B′, C). The inventors propose an approach that randomly samples data points (a, b), (b, a), (b′, c), or (c, b′) during training and applies transitive modeling. For simplicity, the present explanation considers the pair (a, b). Since the model is trained to predict modality C from B, it can infer the pseudo data point @ from b. Now we train the transformer to predict point a using the newly inferred sample c in a way that minimizes the loss with respect to the original sample a, ensuring that all our modalities are aligned (FIG. 4c). In this way, we model the conditional distribution of the missing pair (C, A)—which, due to commutativity, is equal to (A, C). This idea has some conceptual similarities to cycle consistency. However, the method is much more general since it can be applied to many combinations of modalities as long as there is a linking modality, as shown on FIG. 4d.

In fact, upon closer inspection, transitive modeling is quite different from cycle consistency. The most popular version of cycle consistency was introduced in CycleGAN [Zhu et al. 2017]. Given an input a in domain/modality A, one wants to generate an aligned output b in domain/modality B. The model then computes a discriminative loss D on b and a reconstruction loss L on the original a and the predicted â. A different version of cycle consistency was used in MCTN [Pham et al. 2019]: Given aligned inputs (a, b) from modalities A and B, a is used to predict b, and the predicted 6 is used to predict â. Then the reconstruction loss L is applied to compare a and a as well as b and b. Transitive modeling as described herein, on the other hand, starts with the aligned modalities (a, b) and (b′, c), it uses b to predict ê and @ to predict â, the reconstruction loss then compares a and â. Since the present approach uses commutative modeling, the other direction starting from a different sample (b′, c) is also learned. The following summarises the three approaches discussed above:
CycleGAN: Given a, model a→\hat{b}→â and calculate L(a, â)+D(\hat{b}).
MCTN: Given (a, b), model a→\hat{b}→â, and calculate L(a, â)+L(b, \hat{b}).
LoReTTa (method of the disclosure): Given (a, b), model b→ĉ→â and calculate L(a, â).

Thus, transitive modeling as described herein does not simply add another step to cycle consistency by extending a→\hat{b}→â to a→\hat{b}→â. Instead, the approach models b→ĉ→â. Intuitively, this ensures that the model does not “cheat” by memorizing the input a in order to reconstruct a. The approach described herein also does not use a cycle loss, because a is not used as an input and output. Thus, the loss L (a, â) is not cyclic with respect to the model's inputs. However, it still makes sure that the predicted modality is consistent with the data as a whole. This has a similar flavor to cycle consistency, but as can be seen above, it is not the same. In summary, LoReTTa uses masked modeling to transition within modalities, causal modeling to transition between modalities, and vice versa thanks to commutative modeling. Moreover, not all modality combinations need to be available at training time, as the approach uses transitive modeling to predict the missing modalities and connect them to the original data. In the experiments described below, the inventors show that this approach allows to learn very rich multimodal feature representations.

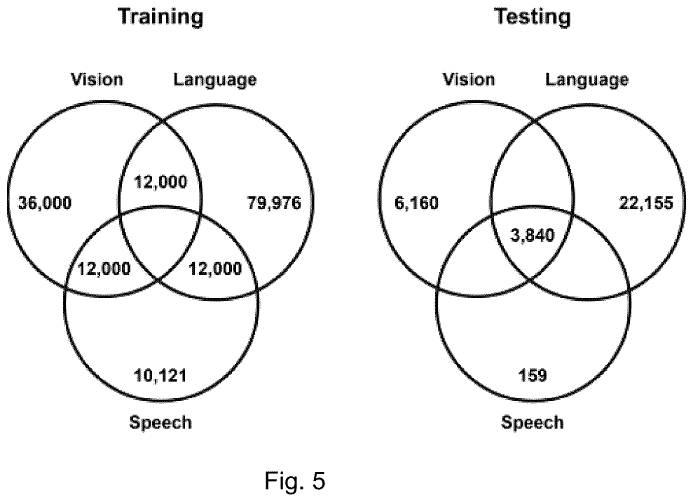

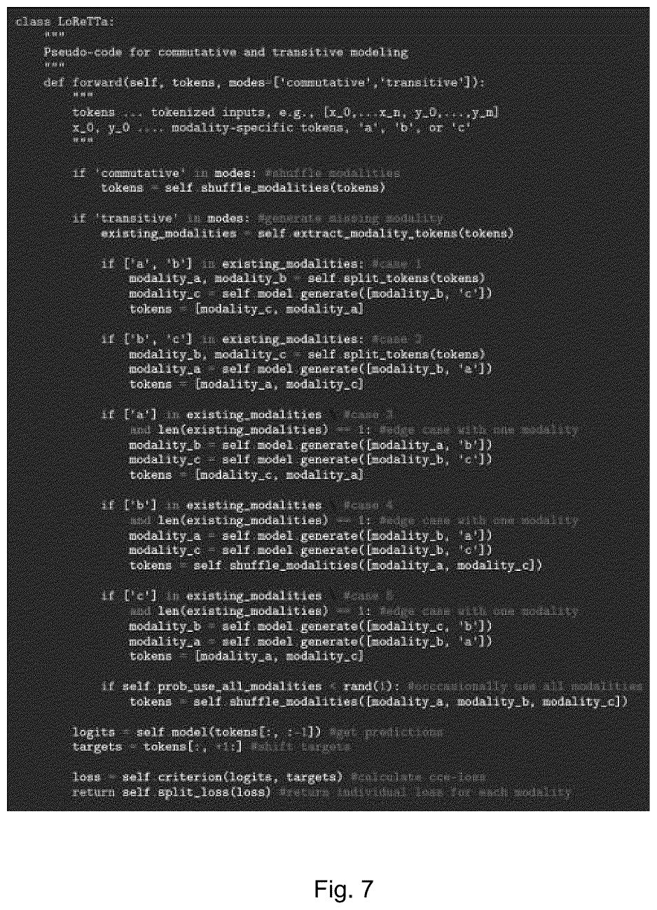

Experimental evaluation protocol. The inventors empirically analyzed LoReTTa on a constructed dataset (SVL-MNIST), a real-world medical dataset (TCGA-OMICS), and an offline reinforcement learning dataset (offline gaming dataset; MUGEN-GAME) with three modalities. For the downstream tasks, they chose object classification, survival prediction, and cross-modal translation, respectively. These three tasks together cover both discriminative and generative problems. The inventors assessed the former through linear probing and the latter in a zero-shot scenario. This allows to directly evaluate the quality of the learned features. The order of the experiments is as follows: First, the inventors performed an ablation study on the constructed dataset to analyze the effect of transitive modeling on different modality combinations. Second, they compared LoReTTa with other methods such as masked (BERT), causal (GPT), and contrastive (CLIP) modeling on the real-world medical dataset. Third, they compare the new model with a state-of-the-art autoregressive cross-modal transformer on the offline gaming dataset. In the Appendix, we list all the optimization hyperparameters and model configurations. FIG. 7 shows pseudocode used for commutative and transitive modeling as described and as used in these evaluations. The pseudocode below gives more insight into how LoReTTa pre-training is implemented. It outlines the main ideas and algorithmic steps to train a model using commutative and transitive modeling. Most importantly, the code shows how both are integrated into the causal modeling framework. SVL-MNIST. The new method was tested on a custom dataset derived from real-world data that includes speech (A), vision (I), and language (T) modalities representing 10 different categories. The speech dataset features about 40,000 spectrograms from AudioMNIST [Khacef et al. 2019], the vision dataset comprises 70,000 images from MNIST [LeCun et al. 2010], and the language dataset consists of 130,000 documents from WineReviews [Thoutt 2018]. We link the datasets via their labels 0-9. This approach results in weakly aligned modalities. For the sake of clarity, we will refer to this dataset as Speech-Vision-Language-MNIST (SVL-MNIST). The dataset was randomly split such that they have exactly the same relationship, as shown in FIG. 3c. In particular, the data was split to obtain bimodal datasets (A, I), (A, T), and (I, T) that each have 12,000 non-overlapping samples. All remaining samples are part of the unimodal datasets A, I, and T. Further detail on the data structure is shown on FIG. 5. SVL-MNIST dataset was divided into training, validation, and test sets. The validation set is merged with the training set after hyperparameter search. To obtain the multimodal dataset with completely missing modality combinations, the inventors considered the three datasets (I, T), (T, A), and (A, I). The first dataset (I, T) consists of 12,000 paired samples from MNIST and WineReviews. The second dataset (T, A) is similarly constructed and contains 12,000 paired samples from WineReviews and AudioMNIST. Another 12,000 samples were taken from AudioMNIST and combined with 12,000 samples from MNIST to get (A, I). All remaining samples are part of the unimodal datasets I, T, and A. There is no dataset with three modalities (I, T, A)—except for testing. Note that none of the samples in the datasets overlap. That is, all datasets have the same relationship as in FIG. 3c. For a fair comparison, the inventors use only the fully aligned subset of the test set to report the final results, since the other sets contain different samples and are of different sizes. However, they kept the data split with the individual unaligned modalities (right side of FIG. 5) to make the dataset more flexible for future experiments.

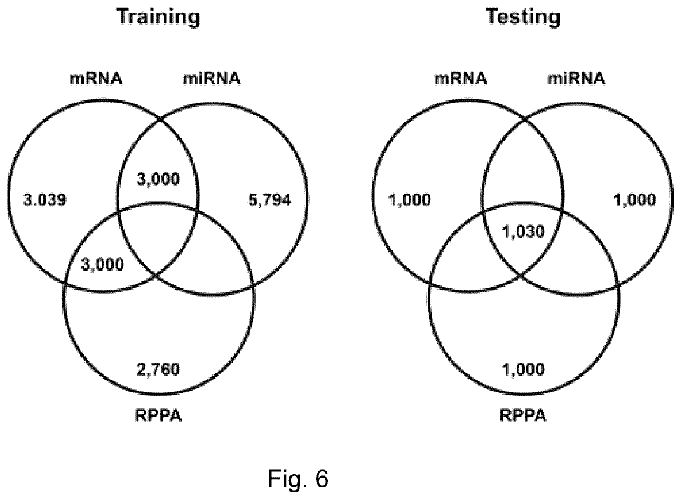

TCGA-OMICS. The medical dataset contains omics (e.g., genomics, proteomics, and transcriptomics) sequencing values from The Cancer Genome Atlas Program (TCGA) [Weinstein et al., 2013]. The inventors selected the three largest subsets, which include messenger ribonucleic acid (mRNA), micro-ribonucleic acid (miRNA), and reverse-phase protein array (RPPA) from up to ~11,000 patients. They aligned the dataset at the patient level and obtained approximately 7,000 patients with all three modalities. To simulate a setting with missing modality combinations, they split the dataset into two subsets (mRNA, miRNA) and (mRNA, RPPA) with non-overlapping 3,500 samples each. They chose mRNA as the linking modality because it is one of the most widely available genetic modalities. TCGA is quite unique in that it is the only publicly available medical dataset with multiple aligned modalities. It is therefore useful for the purpose of testing the methods described herein. Further detail on the data structure is shown on FIG. 6. The TCGA-OMICS dataset contains 11,069 mRNA, 10,824 miRNA, and 7,790 RPPA samples. The inventors aligned the dataset at the patient level and obtained 7,030 data points with three modalities. 1,030 of these were used for testing. The remaining samples were part of the training and validation set (again, the validation set was merged with the training set after hyperparameter tuning). In particular, the training set consisted of the (mRNA, miRNA) and (mRNA, RPPA) datasets, each consisting of 3,000 paired samples. As explained above, the inventors chose mRNA as the linking modality because it is usually the most abundant and common modality available in medical datasets. As above, the inventors use only the fully aligned subset of the test set to report the final results, since the other sets contain different samples and are of different sizes. However, they kept the data split with the individual unaligned modalities (right side of FIG. 6) to make the dataset more flexible for future experiments.

MUGEN-GAME. As a large-scale and multimodal dataset, the inventors chose MUGEN-GAME [Hayes et al. 2022] with 375,000 naturally aligned video (V), audio (A), and text (T) samples collected by a reinforcement learning agent in the closed-world platform game CoinRun. Mugen, the main character, walks, jumps, collects coins, kills monsters, climbs ladders, and dies-triggering various sound effects that are overlaid with background music. All of their adventures are recorded in three-second video clips and audio tracks. A group of human narrators provide rich text descriptions for each scene. The inventors used the most important modality in video games, video, as the linking modality and consider the disjoint datasets (V, A) and (V, T) in the final experiments. MUGEN-GAME consists of 375,368 fully aligned samples. It was divided into a training, validation, and test set of sizes 349, 666, 12,851, and 12,851, respectively. The inventors randomly paired video and audio as well as video and text files. This resulted in two disjoint datasets of size 174,833 each for training.

Implementation details. For the first two experiments (SVL-MNIST and TCGA-OMICS data), the inventors used a transformer decoder with 8 layers and 8 attention heads, with an embedding dimension of 512 and query, key, and value dimensions of 64 each. This compact architecture has proven effective in various tasks and has been widely used in the literature (see e.g. Li et al. 2023). The inventors applied a single parameterized embedder to encode tokens and add modality-specific learned position embeddings (as described in Ramesh et al. 2021, Wang and Cho 2019, Aghajanyan et al. 2023). For optimization, the AdamW algorithm was used with a learning rate of 6e-4, a weight decay factor of 0.1, and a gradient clipping of 1. The learning rate undergoes a 10-fold decay using cosine annealing and a linear warm-up during the first couple hundred steps. For the third experiment (MUGEN-GAME), the inventors use exactly the same training hyperparameters and model configurations as in the baseline model described in [Hayes et al. 2022]. In particular, the transformer has 12 layers, 8 attention heads, and an embedding dimension of 768. The query, key, and value dimensions are each 96.

Models pre-trained with a language learning paradigm share a similar set of hyperparameters. This is consistent with current best practices for state-of-the-art (multimodal) foundation models based on transformers. Specifically, the inventors use the AdamW optimizer with betas of (0.9, 0.95), epsilon of 1e-8, weight decay of 0.1, and gradient clipping at 1.0. The learning rate starts at 1e-7, increases linearly to 6e-4, and gradually decays to 6e-5 according to a cosine schedule. To ensure that the model sees batches containing different modalities and modality combinations during training, the inventors accumulated batches across different data loaders. For CLIP, they used betas of (0.9, 0.98), epsilon of 1e-6, and weight decay of 0.2. The maximum learning rate starts at 5e-4 and ends at 5e-5. The list of batch sizes, warm-up steps, and total training steps for each experiment can be found in Table 5 and Table 6. The above setting applies to the SVL-MNIST and TCGA-OMICS experiments. The MUGEN-GAME experiments follow the exact hyperparameters as Hayes et al. 2022-except that the training was performed for 142,000 steps. Tokenization scheme. Due to the low dimensionality of the SVL-MNIST dataset, the inventors directly encoded the raw byte streams by binning the continuous values to a dictionary of 256 each. TCGA-OMICS data can be very high-dimensional and is best handled differently. For example, an mRNA expression array typically contains more than 20,500 entries. Therefore, the inventors first reduced the dimensions by a factor of 10 using PCA and then binned the values to a dictionary of 1,000. The final input sizes are 2,048, 64, and 16, respectively-retaining their original relative lengths. The high-dimensional video and audio samples in MUGEN-GAME are tokenized identically to Hayes et al. 2022 using their pre-trained VQ-VAE encoders.

Linear probing. In the SVL-MNIST experiments, we freeze the backbone and train a linear classifier on top. SGD is used as the optimizer with the Nesterov momentum set to 0.9. The initial learning rate is 0.1, but it gradually decreases to zero during training by cosine annealing. We do not use weight decay. The batch size is 16, and the number of epochs (based on the validation sets) is listed in Table 7. For the TCGA experiments, we fit a Cox proportional hazards model with an elastic net penalty to the extracted features. The weights for the regularization terms L1 and L2 are both set to 0.5. Training is stopped when one of the following criteria is met: to l=1e-7 or iter=100000. The underlying optimization algorithm is based on coordinate descent, which successively minimizes the objective function along one direction at a time. It is particularly effective for problems with many features.

### Theoretical Analysis

We consider a dataset with modalities X₁, . . . , X_{N} to be aligned if there exists a subset S sampled from a joint probability distribution P (X₁, . . . , X_{N}; Y). Here, Y represents the label space. This form of alignment, where only labels are shared across modalities, is called weak alignment [Castrejon et al. 2016]. Conversely, when there is a functional relationship at the level of physical objects, we consider the alignment to be strong [Castrejon et al., 2016]. The definition of strong and weak alignment also extends to datasets where we do not have all modality combinations at once. For example, during data collection, we may recover only the paired samples (x₁, x₂) and

$$( {x}_{2}^{′} , {x}_{3}^{′} ) ,$$

where x₂ and

$${x}_{2}^{′}$$

do not belong to the same object/subject. Thus, we have datasets of the form (X₁, X₂) and (X₂, X₃) instead of (X₁, X₂, X₃). This is different from the case where the dataset still contains some samples of the form (x₁, x₂, x₃), which was considered in previous work. To model the unseen relationship (X₁, X₃) in a self-supervised way, we cannot simply use techniques like masked modeling or causal modeling (because there are no aligned observations for the modalities X₁ and X₃). The neural network would have to implicitly learn

$$p ( {x}_{3} \vert {x}_{1} ) = \frac{p ( {x}_{1} , {x}_{3} )}{p ( {x}_{1} )} \qquad Equation ( 2 )$$

by deriving p(x₁, x₃)=Σₓ_{₂} p(x₁, x₂, x₃) and p(x₁, x₂, x₃)=p(x₃|x₂, x₁)p(x₂|x₁)p(x₁) from the chain rule of probability. Empirically (see [Asai and Hajishirzi, 2020, Li and Tou Ng 2022, Yanaka et al. 2021]), both the unidirectional and bidirectional approaches fail this task even within one modality because it is difficult to model p(x₃|x₂, x₁) due to the missing set (X₁, X₂, X₃). This is where the proposed transitive modeling paradigm comes in.

Suppose we have a dataset of the form (X₁, X₂), (X₂, X₃), . . . , (X_{N-1}, X_{N}), where Xₖ and Xₗ are not aligned when k+1≠l. By applying causal modeling to all pairs, we can learn the transition X₁→X₂→ . . . →X_{N-1}→X_{N}. Adding our proposed commutative modeling, we get an even stronger bidirectional relation: X₁↔X₂↔ . . . ↔X_{N-1}↔X_{N}. Now, let us interpret each modality as a node on a high-dimensional graph. This gives us a connected graph (minimum spanning tree) where we can walk from one modality to any other modality. Thus, given a real data point xᵢ, we can use transitive modeling to sample pseudo data points xⱼ by transitioning from xᵢ to xⱼ. Having sampled many pairs (xᵢ, xⱼ), we get a new dataset (Xᵢ, Xⱼ). This can be used again in the generative pre-training process to learn the new transition Xᵢ↔Xⱼ. We apply this idea to all i and j. In the end, we learn the conditional distribution between all samples and obtain a fully connected graph. This idea holds for more complicated modality combinations as long as there is a bridging modality, i.e., we have a spanning tree (see FIG. 4d). We can also sample all missing tuples (xₖ, . . . , x₁). Thus, LoReTTa allows us to approximate any missing joint probability distribution P(xₖ, . . . , xₗ) by sampling and training with the missing modality combinations.

Ideally, there would be no generalization error after pre-training. In practice, however, we would not be able to accurately recover the ground truth of the missing modality with perfect accuracy if it were available. For the datasets (X₁, X₂) and (X₂, X₃), the learned generative model f would make the following errors:

$$f ( {x}_{1} \vert {x}_{2} ) = {x}_{1} + {e}_{2 , 1} , f ( {x}_{2} \vert {x}_{1} ) = {x}_{2} + {e}_{1 , 2} , \\ f ( {x}_{2} \vert {x}_{3} ) = {x}_{2} + {e}_{3 , 2} , f ( {x}_{3} \vert {x}_{2} ) = {x}_{3} + {e}_{2 , 3} \qquad Equation ( 3 )$$

where all e_{i,j} are vector-valued error terms. Without loss of generality, we do not keep track of the sign of the error, since we can always write e_{i,j}′=−1·e_{i,j}. Assuming that f is differentiable and using the multivariate Taylor expansion, we obtain

$${x}_{3} = f ( {x}_{3} \vert f ( {x}_{2} \vert {x}_{1} ) + {e}_{1 , 2} ) + {e}_{2 , 3} \approx f ( {x}_{3} \vert f ( {x}_{2} \vert {x}_{1} ) ) + {J}_{f} ( {x}_{3} \vert f ( {x}_{2} \vert {x}_{1} ) ) {J}_{f} ( {x}_{2} \vert {x}_{1} ) {e}_{1 , 2} + {e}_{2 , 3} \qquad Equation ( 4 )$$

where J_{f} is the Jacobian of f. By iteratively applying the Taylor rule, a more general error propagation formula is obtained for longer chains. Intuitively, errors from the first transitions are amplified more and more. However, because we use the predicted x₃ to reconstruct x₁, we can actually bound the error term e_{1,3}:=J_{f}(x₃|f(x₂|x₁))J_{f}(x₂|x₁)e_{1,2}+e_{2,3}. Recall that we have a ground truth x₁ for which the following is true:

$$\begin{matrix}{x}_{1} = f ( {x}_{1} \vert {x}_{3} ) + {e}_{3 , 1} = f ( {x}_{1} \vert f ( {x}_{3} \vert {x}_{2} ) + {e}_{2 , 3} ) + {e}_{3 , 1} \\ = f ( {x}_{1} \vert f ( {x}_{3} \vert f ( {x}_{2} \vert {x}_{1} ) + {e}_{1 , 2} ) + {e}_{2 , 3} ) + {e}_{3 , 1}\end{matrix} \qquad Equation ( 5 )$$

Since we are minimizing the reconstruction error of x₁ given \hat{x}₃=x₃+e_{1,3} during backpropagation, the error terms e_{1,2} and e_{2,3} must be bounded. And since they make up the error term e_{1,3}, it too must be bounded, as long as f and J_{f} are.

### Experimental Evaluation Results

### SVL-MNIST

In the first experiment, the inventors trained one model for each modality (A, I, and T) using causal masked modeling (CM3). They then trained four additional models using commutative causal masked modeling (C2M3) on the bimodal datasets (A, I), (A, T), and (I, T), as well as the trimodal dataset (A, I, T). These seven models serve as unimodal, multimodal, and “upper” baselines, respectively. Then, using C2M3 with T as the linking modality, they trained models simultaneously on both (I, T) and (A, T), and repeated this process for all modality combinations. Next, they initialized LoReTTa with the C2M3 model weights to explicitly merge the bimodal datasets via the linking modality. This pretraining approach speeds up the training compared to full LoReTTa training from scratch. After pre-training, all models were frozen and evaluated in a low-data regime with only 1,000 labeled samples (100 per class). Three runs were performed, each with a newly randomized subset, and the classification accuracy was reported along with the perplexity on the test set. Note that we only train the models on the modalities that the model saw during pre-training. This also means that during probing, the linear classifier will see some samples of the unseen modality pair. However, the pre-trained backbone itself did not see them. In this way, we can analyze how the model combines previously unseen mixture of input modalities (modality combinations).

When pre-trained only on the pairs (T, I) and (T, A), LoReTTa achieves a remarkably low perplexity of 5.04 on the unseen pair (I, A), as shown in Table 1, significantly outperforming the baseline non-transitive model trained with C2M3, which has a perplexity of 104.27. This trend extends to other combinations as well. For example, the model trained on (A, I) and (A, T) and evaluated on (I, T) has a perplexity of 3.13 (LoReTTa) compared to 9.70 (C2M3). Similarly, training on (I, T) and (I, A) and evaluating on (T, A) yields a perplexity of 11.21 (LoReTTa) versus 30.88 (C2M3). Importantly, LoReTTa consistently achieves similar perplexities for unseen and seen modality combinations, demonstrating its ability to effectively learn the missing distribution. A similar trend appears in the downstream task (Table 2). In almost all cases, LoReTTa consistently outperforms C2M3 on the unimodal datasets A, I, and T, as well as the bimodal datasets (A, I), (A, T), or (I, T). In a nutshell, if any of the modality pairs are missing, training a model with LoReTTa is recommended because it uniquely integrates these modalities and improves accuracy compared to any single-modality model. In fact, providing a few samples with three modalities during linear probing further increases the classification score of models pre-trained with LoReTTa. Interestingly, the “upper” baseline trained on all aligned modalities often lags behind LoReTTa despite favorable perplexity scores. This strongly suggests some kind of negative transfer or modality competition that LoReTTa is able to overcome.

TABLE 1
Perplexity on the SVL-MNIST test set. The subscript describes
the pre-training datasets with image (I), text (T), or speech
(A), while the blue colors highlight the unseen modality pairs.

| | | Testing | | | | | |
|---|---|---|---|---|---|---|---|
| Training | | I | T | A | (I, T) | (I, A) | (T, A) |
| Unimodal | CM3_{(I)} | 1.55 | — | — | — | — | — |
| baselines | CM3_{(T)} | — | 2.05 | — | — | — | — |
| | CM3_{(A)} | — | — | 18.63 | — | — | — |
| Bimodal | C2M3_{(I, T)} | 1.62 | 2.28 | — | 1.76 | — | — |
| baselines | C2M3_{(I, A)} | 1.61 | — | 20.09 | — | 4.42 | — |
| | C2M3_{(T, A)} | — | 2.25 | 19.85 | — | — | 10.68 |
| Multimodal | C2M3_{(I, T), (I, A)} | 1.64 | 2.19 | 21.37 | 1.76 | 4.39 | 30.88 |
| baselines | C2M3_{(T, I), (T, A)} | 1.65 | 2.18 | 19.69 | 1.76 | 104.27 | 11.26 |
| | C2M3_{(A, I), (A, T)} | 1.64 | 2.19 | 23.45 | 9.70 | 4.66 | 11.92 |
| LoReTTA | LoReTTa_{(I, T), (I, A)} | 1.56 | 2.17 | 18.77 | 1.72 | 3.14 | 11.21 |
| | LoReTTa_{(T, I), (T, A)} | 1.59 | 2.10 | 18.95 | 1.70 | 5.04 | 10.03 |
| | LoReTTa_{(A, I), (A, T)} | 1.60 | 2.14 | 20.35 | 3.13 | 4.36 | 10.65 |
| upper | C2M3_{(I, T, A)} | 1.55 | 2.35 | 19.43 | 1.72 | 4.25 | 10.55 |
| baseline | | | | | | | |

TABLE 2
After pre-training, a classifier is trained on the frozen models. Classification accuracy is analyzed
in a few-shot scenario with 100 samples per class over three trials on SVL-MNIST. The subscript
denotes the pre-training datasets with image (I), text (T), or speech (A) modalities, while the
bold values highlighting the results on the unseen modality tuple during pre-training.

| | | Testing | | | | | | |
|---|---|---|---|---|---|---|---|---|
| Training | | I | T | A | (I, T) | (I, A) | (T, A) | (I, T, A) |
| Unimodal | CM3_{(I)} | 79.7 ± 0.8 | — | — | — | — | — | — |
| baselines | CM3_{(T)} | — | 57.0 ± 0.5 | — | — | — | — | — |
| | CM3_{(A)} | — | — | 80.3 ± 0.6 | — | — | — | — |
| Bimodal | C2M3_{(I, T)} | 82.9 ± 0.6 | 61.9 ± 0.7 | — | 89.7 ± 0.2 | — | — | — |
| baselines | C2M3_{(I, A)} | 83.8 ± 0.5 | — | 79.9 ± 0.2 | — | 89.9 ± 0.1 | — | — |
| | C2M3_{(T, A)} | — | 61.1 ± 0.4 | 79.5 ± 0.2 | — | — | 85.2 ± 0.3 | — |
| Multimodal | C2M3_{(I, T), (I, A)} | 83.1 ± 0.8 | 59.8 ± 0.4 | 80.7 ± 0.4 | 87.9 ± 0.6 | 89.3 ± 0.2 | 71.2 ± 0.4 | 87.3 ± 0.4 |
| baselines | C2M3 _{(T, I), (T, A)} | 81.7 ± 0.1 | 63.2 ± 0.6 | 78.5 ± 0.6 | 89.1 ± 0.3 | 72.9 ± 0.2 | 84.8 ± 0.5 | 83.2 ± 0.4 |
| | C2M3_{(A, I), (A, T)} | 80.8 ± 0.4 | 63.9 ± 0.6 | 82.8 ± 0.7 | 77.8 ± 0.5 | 89.8 ± 0.1 | 88.1 ± 0.5 | 89.9 ± 0.5 |
| LoReTTA | LoReTTa_{(I, T), (I, A)} | 82.7 ± 0.9 | 62.8 ± 0.4 | 82.5 ± 0.6 | 88.5 ± 0.7 | 89.7 ± 0.1 | 84.0 ± 0.2 | 90.7 ± 0.6 |
| | LoReTTa_{(T, I), (T, A)} | 81.2 ± 0.9 | 63.3 ± 0.4 | 81.0 ± 0.5 | 89.0 ± 0.3 | 80.9 ± 0.6 | 85.5 ± 0.5 | 87.8 ± 0.3 |
| | LoReTTa_{(A, I), (A, T)} | 80.1 ± 0.3 | 62.1 ± 0.6 | 84.2 ± 0.5 | 83.0 ± 0.7 | 90.4 ± 0.3 | 89.0 ± 0.2 | 91.6 ± 0.7 |
| upper | C2M3_{(I, T, A)} | 80.3 ± 0.4 | 58.3 ± 0.4 | 79.3 ± 0.7 | 85.2 ± 0.2 | 85.3 ± 0.4 | 82.5 ± 0.3 | 88.5 ± 0.2 |
| baseline | | | | | | | | |

### TCGA-OMICS

Transformers were pretrained with C2M3 and LoReTTa was initialized with the weights of the C2M3 model, as in the SVL-MNIST experiments. For GPT, the inventors simply used the algorithm of C2M3, but disabled causal masking and commutative switching. BERT uses the same transformer architecture; but the inventors simply changed the unidirectional attention mask to a bidirectional attention mask. To directly demonstrate the benefit of transitive modeling, the inventors extended both GPT and BERT using the transitive modeling technique described herein. The resulting models are named T-GPT and T-BERT. These models use transitive modeling but not commutative modeling. The CLIP-based model consists of 3 encoders (each using our same transformer architecture) and a contrastive loss [Khosla et al. 2020] to align the features. After pre-training, for each model, the inventors extracted the embeddings and fit a Cox proportional hazards model with an elastic net penalty for each modality combination using all available labels. In 6 out of 7 test sets, the LoReTTa pre-trained transformer achieves the highest c-index (Table 3). Most importantly, this includes the unseen modality pair (miRNA, RPPA) and the triplet (mRNA, miRNA, RPPA). The only frameworks on par with LoReTTa are T-BERT and CLIP on the unseen dataset (miRNA, RPPA). On the unseen trimodal dataset, T-GPT and CLIP give good results but are far behind LoReTTa. Overall, transitive modeling mostly improves the performance of all models. Notably, LoReTTa and CLIP are the only strategies that consistently allow for positive or neutral transfer, which is not always the case with other frameworks. A major drawback of contrastive learning is that it requires a separate encoder for each additional modality. In addition, CLIP-based approaches only excel at large batch sizes. Here, the inventors compared models with the same computational constraints. In order to investigate how CLIP could compare to LoReTTa with additional computing capacity, they spent their limited resources on additional computing capacity, allowing them to scale up the CLIP experiment by increasing the batch size by a factor of 5 and the number of training steps by a factor of 3. This model, referred to as Large CLIP (L-CLIP) consistently improves the c-index of CLIP but requires 3× more VRAM than LoReTTa. As can be seen in Table 3, none of the models achieve the same performance as LoReTTa when making trimodal predictions, or when making two out of the 3 types of bimodal predictions (the third type being associated with the same accuracy only with T-BERT and CLIP. All of the models come very far from LoReTTa when using the unseen pairs as bimodal inputs (M, R) or as part of trimodal inputs (M, I, R). This shows that the LoReTTa approach results in higher performance than comparative models when using the same amount of computational resources, and that increased computational resource allocation to comparative models does increase performance but not to the same level as LoReTTa. In other words, the data demonstrates that the approach described herein enables multimodal predictions with higher accuracy than comparative approaches with the same computational efficiency in contexts where fully aligned training data is not available. In other words, the proposed approach provides a more computationally efficient method to learn from multimodal data in the presence of one or more missing tuples.

In contrast to the SVL-MNIST experiments, the 3-modal “upper-bound” model suffers less from negative transfer or modality competition and achieves the best result for the majority of modality combinations. However, as explained above, the availability of such complete aligned data is extremely rare in the field of medical data. Therefore, a model such as the upper bound model is in practice not attainable in the majority of cases.

TABLE 3
After pre-training, a Cox proportional hazards model is
trained on the extracted features from TCGA-OMICS. We
use mixtures of mRNA (M), miRNA (I), and RPPA (R) as inputs.
Bold highlights the c-index on the unseen tuples, and
the underline highlights the second-highest value.

| | Testing | | | | | | |
|---|---|---|---|---|---|---|---|
| Training | M | I | R | (M, I) | (M, R) | (I, R) | (M, I, R) |
| BERT | 0.592 | 0.621 | 0.594 | 0.595 | 0.613 | 0.594 | 0.610 |
| T-BERT | 0.573 | 0.618 | 0.626 | 0.580 | 0.591 | 0.623 | 0.608 |
| GPT | 0.575 | 0.590 | 0.611 | 0.585 | 0.576 | 0.606 | 0.588 |
| T-GPT | 0.616 | 0.607 | 0.599 | 0.620 | 0.619 | 0.611 | 0.622 |
| CLIP | 0.561 | 0.603 | 0.587 | 0.610 | 0.600 | 0.623 | 0.612 |
| L-CLIP | 0.588 | 0.615 | 0.587 | 0.620 | 0.599 | 0.614 | 0.620 |
| C2M3 | 0.621 | 0.599 | 0.599 | 0.624 | 0.620 | 0.571 | 0.624 |
| LoReTTa | 0.652 | 0.623 | 0.563 | 0.660 | 0.652 | 0.623 | 0.657 |
| C2M3_{(M, I, R)} | 0.665 | 0.635 | 0.645 | 0.643 | 0.671 | 0.650 | 0.620 |

### MUGEN-GAME

Recently, there has been a growing interest in cross-modal generation. While much research has focused on text-to-video or video-to-text translation, other cross-modal tasks such as video-to-audio, audio-to-video, text-to-audio, or audio-to-text have not been investigated as thoroughly. In this large-scale experiment, the inventors addressed the latter task. They used video as the linking modality and considered the disjoint datasets (video, audio) and (video, text). Splitting the training set equally resulted in about 187,500 pairs in each set. They use the same optimization hyperparameters and model architecture as the state-of-the-art upper baseline MMGPT [Hayes et al. 2022] to train their version of (MM) GPT and also LoReTTa. As seen in the TCGA-OMICS experiment above, BERT, unsurprisingly failed to generate long-range coherent samples (see results with mRNA). Therefore, the inventors did not use BERT in this experiment. They also did not train a CLIP model, as this would require training a text diffusion model (or equivalent generator) on top of the pre-trained encoder, which is neither end-to-end nor straightforward. For GPT, they trained the model to generate video from audio and text from video. In this way, they forced the model to implicitly learn how to caption audio tracks. In the case of LoReTTa, the inventors model the transition between audio and text directly through transitive modeling. Remarkably, GPT trained on two bimodal datasets outperforms the audio-to-text baseline in terms of ROUGE, showing strong positive transfer (Table 4). LoReTTa further improves on GPT and even rivals the video-to-text baseline with regards to METEOR and ROUGE. The BLEU4 values are low for both models. Since BLEU involves exact n-gram matching, these results are to be expected given the strict data constraints.

TABLE 4
Both GPT and LoReTTa are trained on disjoint (video, audio)
and (video, text) pairs on MUGEN-GAME. The inventors then
evaluate the models on the unseen task of audio captioning
using BLEU4, METEOR, and ROUGE. MMGPTs represent the upper-
bound models. BLEU4, METEOR, and ROUGE are widely used machine
translation metrics to compare the similarity between two
texts at the word level (n-gram to be more exact). The higher
the value, the better. While BLEU4 focuses on exact n-gram
matches, METEOR takes into account synonyms and ROUGE considered
the sentence structure as well.

| Method | Train | Test | BLEU4 | METEOR | ROUGE |
|---|---|---|---|---|---|
| GPT | A → V, V → T | A → T | 1.7 | 18.5 | 30.7 |
| LoReTTa | A ↔ V ↔ T | A → T | 2.8 | 20.8 | 34.7 |
| MMGPT | A → T | A → T | 6.7 | 19.4 | 27.1 |
| MMGPT | V → T | V → T | 7.8 | 21.3 | 29.1 |

### CONCLUSION

With LoReTTa, the inventors introduced an innovative self-supervised learning framework for multimodal integration that learns any missing joint conditional distribution given a linking modality. They demonstrated this theoretically and practically. In particular, the new method combines the rules of commutativity and transitivity to model the multimodal datasets (A, C) and (A, B, C) given the two non-overlapping datasets (A, B) and (B,C). The inventors showed that the extracted features of a transformer pre-trained with LoReTTa are very expressive for all modality combinations, including the unseen ones. While they only evaluated the new algorithm on datasets with three modalities, it is much more general because it can be used with any number of modalities and any mixture of modalities. As long as there is a chain of aligned modalities in the dataset, LoReTTa is able to learn the transition (Xᵢ→ . . . →Xⱼ), . . . , (Xᵢ→ . . . →xₖ) to model the missing distribution P(Xⱼ, . . . , Xₖ) (as shown in FIG. 4d). To the inventors' knowledge, this scenario has never been considered in the literature without training an ensemble of contrastive models based on the ideas of CLIP-most notably Wav2CLIP [Wu et al. 2022] and its extension ImageBind [Girdhar et al. 2023], which as shown above is much more computationally intensive.

These examples show that LoReTTa can serve as a basis for training very powerful multimodal generative and discriminative models that will be useful in many areas of research. For example, LoReTTa was designed to improve the quality of neural networks that contribute to society, for example by training more accurate multimodal systems that can help doctors and other practitioners in their daily work. LoReTTa is best used in a setting where we are missing some modality combinations, and there is at least one connecting modality. The method can still be used in datasets where some samples have all modality combinations. Although the inventors have not analyzed this scenario in the present examples, LoReTTa is likely to provide benefits by augmenting those data points that are still missing the remaining modalities.

TABLE 5
The batch size, number of warm-up steps, and number of total
training steps for each model in the SVL-MNIST experiment.

| Method | Batch size | Warm-up steps | Total Steps |
|---|---|---|---|
| CM2_{(I)} | 64 | 1,000 | 23500 |
| CM2_{(T)} | 64 | 1,000 | 16300 |
| CM2_{(A)} | 64 | 1,000 | 13400 |
| C2M3_{(I, T)} | 64 | 200 | 18800 |
| C2M3_{(I, A)} | 64 | 200 | 18800 |
| C2M3_{(T, A)} | 16 | 200 | 18800 |
| C2M3_{(I, T), (I, A)} | 16 | 400 | 37500 |
| C2M3_{(T, I), (T, A)} | 16 | 400 | 37500 |
| C2M3_{(A, I), (A, T)} | 16 | 400 | 37500 |
| LoReTTA_{(I, T), (I, A)} | 16 | 400 | 9400 |
| LoReTTA_{(T, I), (T, A)} | 16 | 400 | 9400 |
| LoReTTA_{(A, I), (A, T)} | 16 | 400 | 9400 |
| C2M3_{(I, T, A)} | 16 | 400 | 92000 |

TABLE 6
The batch size, number of warm-up steps, and number of total
training steps for each model in the TCGA-OMICS experiment.

| Method | Batch size | Warm-up steps | Total Steps |
|---|---|---|---|
| BERT | 16 | 400 | 5500 |
| T-BERT | 16 | 400 | 1100 |
| GPT | 16 | 400 | 5500 |
| T-GPT | 16 | 400 | 1100 |
| CLIP | 16 | 400 | 1200 |
| L-CLIP | 80 | 400 | 3800 |
| C2M3 | 16 | 400 | 5500 |
| LoReTTa | 16 | 400 | 1300 |
| C2M3_{(M, I, R)} | 16 | 400 | 9900 |

TABLE 7
Number of training epochs to fi the linear classifier on the SVL-MNIST dataset
for each dataset containing different modalities and modality combinations.

| | Testing | | | | | | |
|---|---|---|---|---|---|---|---|
| Training | I | T | A | (I, T) | (I, A) | (T, A) | (I, T, A) |
| CM3_{(I)} | 100 | — | — | — | — | — | — |
| CM3_{(T)} | — | 100 | — | — | — | — | — |
| CM3_{(A)} | — | — | 100 | — | — | — | — |
| C2M3_{(I, T)} | 100 | 100 | — | 100 | — | — | — |
| C2M3_{(I, A)} | 100 | — | 100 | — | 100 | — | — |
| C2M3_{(T, A)} | — | 100 | 100 | — | — | 100 | — |
| C2M3_{(I, T), (I, A)} | 500 | 100 | 100 | 500 | 500 | 500 | 500 |
| C2M3_{(T, I),} _{(T, A)} | 500 | 100 | 100 | 500 | 500 | 500 | 500 |
| C2M3_{(A, I), (A, T)} | 500 | 100 | 100 | 500 | 500 | 500 | 500 |
| LoReTTa_{(I, T), (I, A)} | 500 | 100 | 100 | 500 | 500 | 500 | 500 |
| LoReTTa_{(T, I), (T, A)} | 500 | 100 | 100 | 500 | 500 | 500 | 500 |
| LoReTTa_{(A, I), (A, T)} | 500 | 100 | 100 | 500 | 500 | 500 | 500 |
| C2M3_{(I, T, A)} | 500 | 100 | 500 | 500 | 500 | 500 | 500 |

### REFERENCES

Jimmy Lei Ba, Jamie Ryan Kiros, and Geoffrey E Hinton. Layer normalization. arXiv preprint arXiv: 1607.06450, 2016. 4
Peng Bo. Blinkdl/rwkv-Im: 0.01, August 2021. URL https://doi.org/10.5281/zenodo.5196577
Aakanksha Chowdhery, Sharan Narang, Jacob Devlin, Maarten Bosma, Gaurav Mishra, Adam Roberts, Paul Barham, Hyung Won Chung, Charles Sutton, Sebastian Gehrmann, et al. Palm: Scaling language modeling with pathways. arXiv preprint arXiv: 2204.02311, 2022
Tri Dao, Dan Fu, Stefano Ermon, Atri Rudra, and Christopher Re. Flashattention: Fast and memory-efficient exact attention with io-awareness. In Advances in Neural Information Processing Systems (NeurIPS), volume 35, pages 16344-16359, 2022.
Michael Poli, Stefano Massaroli, Eric Nguyen, Daniel Y Fu, Tri Dao, Stephen Baccus, Yoshua Bengio, Stefano Ermon, and Christopher Ré. Hyena hierarchy: Towards larger convolutional language models. arXiv preprint arXiv: 2302. 10866, 2023.
Alec Radford, Jeff Wu, Rewon Child, David Luan, Dario Amodei, and Ilya Sutskever. Language models are unsupervised multitask learners, 2019.
Ashish Vaswani, Noam Shazeer, Niki Parmar, Jakob Uszkoreit, Llion Jones, Aidan N Gomez, Łukasz Kaiser, and Illia Polosukhin. Attention is all you need. In 31st Conference on Neural Information Processing Systems (NIPS), page 6000-6010. Curran Associates, Inc., 2017
Biao Zhang and Rico Sennrich. Root mean square layer normalization. In Advances in Neural Information Processing Systems (NeurIPS), volume 32, 2019
Armen Aghajanyan, Bernie Huang, Candace Ross, Vladimir Karpukhin, Hu Xu, Naman Goyal, Dmytro Okhonko, Mandar Joshi, Gargi Ghosh, Mike Lewis, et al. Cm3: A causal masked multimodal model of the internet. arXiv preprint arXiv: 2201.07520, 2022
Armen Aghajanyan, Lili Yu, Alexis Conneau, Wei-Ning Hsu, Karen Hambardzumyan, Susan Zhang, Stephen Roller, Naman Goyal, Omer Levy, and Luke Zettlemoyer. Scaling laws for generative mixed-modal language models. arXiv preprint arXiv: 2301.03728, 2023
Mathilde Caron, Hugo Touvron, Ishan Misra, Herve Jegou, Julien Mairal, Piotr Bojanowski, and Armand Joulin. Emerging properties in self-supervised vision transformers. In 2021 IEEE/CVF International Conference on Computer Vision (ICCV), pages 9650-9660. IEEE, 2021. doi: 10.1109/ICCV48922.2021. 00951.
Jean-Baptiste Alayrac, Jeff Donahue, Pauline Luc, Antoine Miech, lain Barr, Yana Hasson, Karel Lenc, Arthur Mensch, Katherine Millican, Malcolm Reynolds, et al. Flamingo: a visual language model for few-shot learning. In Advances in Neural Information Processing Systems (NeurIPS), volume 35, pages 23716-23736, 2022
Andrea Agostinelli, Timo I Denk, Zalán Borsos, Jesse Engel, Mauro Verzetti, Antoine Caillon, Qingqing Huang, Aren Jansen, Adam Roberts, Marco Tagliasacchi, et al. Musiclm: Generating music from text. arXiv preprint arXiv: 2301.11325, 2023
Mark Chen, Alec Radford, Rewon Child, Jeffrey Wu, Heewoo Jun, David Luan, and Ilya Sutskever. Generative pretraining from pixels. In International Conference on Machine Learning (ICML), pages 1691-1703. PMLR, 2020
Lluis Castrejon, Yusuf Aytar, Carl Vondrick, Hamed Pirsiavash, and Antonio Torralba. Learning aligned cross-modal representations from weakly aligned data. In IEEE Conference on Computer Vision and Pattern Recognition (CVPR), pages 2940-2949, 2016
Jordan Hoffmann, Sebastian Borgeaud, Arthur Mensch, Elena Buchatskaya, Trevor Cai, Eliza Rutherford, Diego de Las Casas, Lisa Anne Hendricks, Johannes Welbl, Aidan Clark, et al. An empirical analysis of compute-optimal large language model training. In Advances in Neural Information Processing Systems (NeurIPS), volume 35, pages 30016-30030, 2022
Jacob Devlin, Ming-Wei Chang, Kenton Lee, and Kristina Toutanova. BERT: Pre-training of deep bidirectional transformers for language understanding. In Proceedings of the 2019 Conference of the North American Chapter of the Association for Computational Linguistics: Human Language Technologies, Volume 1 (Long and Short Papers), pages 4171-4186. Association for Computational Linguistics, 2019
Thomas Hayes, Songyang Zhang, Xi Yin, Guan Pang, Sasha Sheng, Harry Yang, Songwei Ge, Qiyuan Hu, and Devi Parikh. Mugen: A playground for video-audio-text multimodal understanding and generation. In 17th European Conference on Computer Vision (ECCV), pages 431-449. Springer, 2022.
Alec Radford, Karthik Narasimhan, Tim Salimans, Ilya Sutskever, et al. Improving language understanding by generative pre-training, 2018
Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International Conference on Machine Learning (ICML), pages 8748-8763. PMLR, 2021b
Rohit Girdhar, Alaaeldin El-Nouby, Zhuang Liu, Mannat Singh, Kalyan Vasudev Alwala, Armand Joulin, and Ishan Misra. Imagebind: One embedding space to bind them all. arXiv preprint arXiv: 2305.05665, 2023
John Jumper, Richard Evans, Alexander Pritzel, Tim Green, Michael Figurnov, Olaf Ronneberger, Kathryn Tunyasuvunakool, Russ Bates, Augustin Žídek, Anna Potapenko, et al. Highly accurate protein structure prediction with alphafold. Nature, 596 (7873): 583-589, 2021.
Kudo and John Richardson. SentencePiece: A simple and language independent subword tokenizer and detokenizer for neural text processing. In Proceedings of the 2018 Conference on Empirical Methods in Natural Language Processing: System Demonstrations (EMNLP), pages 66-71. Association for Computational Linguistics, 2018.
Lyes Khacef, Laurent Rodriguez, and Benoit Miramond. Written and spoken digits database for multimodal learning. https://zenodo.org/record/3515935, 2019
Prannay Khosla, Piotr Teterwak, Chen Wang, Aaron Sarna, Yonglong Tian, Phillip Isola, Aaron Maschinot, Ce Liu, and Dilip Krishnan. Supervised contrastive learning. In 33th Advances in Neural Information Processing Systems (NeurIPS), pages 18661-18673. Curran Associates, Inc., 2020
Yann LeCun, Corinna Cortes, and Christopher J. C. Burges. Mnist handwritten digit database. http://yann.lecun.com/exdb/mnist/,2010
Ruixi Lin and Hwee Tou Ng. Does bert know that the is-a relation is transitive? In 60th Annual Meeting of the Association for Computational Linguistics (Volume 2: Short Papers), pages 94-99. Association for Computational Linguistics, 2022
Jessy Lin, Yuqing Du, Olivia Watkins, Danijar Hafner, Pieter Abbeel, Dan Klein, and Anca Dragan. Learning to model the world with language. arXiv preprint arXiv: 2308.01399, 2023
Kenneth Li, Aspen K Hopkins, David Bau, Fernanda Viegas, Hanspeter Pfister, and Martin Wattenberg. Emergent world representations: Exploring a sequence model trained on a synthetic task. In 11th International Conference on Learning Representations (ICLR), 2023
Andrew Jaegle, Felix Gimeno, Andy Brock, Oriol Vinyals, Andrew Zisserman, and Joao Carreira. Perceiver: General perception with iterative attention. In International Conference on Machine Learning (ICML), pages 4651-4664. PMLR, 2021
Wenhui Wang, Hangbo Bao, Li Dong, Johan Bjorck, Zhiliang Peng, Qiang Liu, Kriti Aggarwal, Owais Khan Mohammed, Saksham Singhal, Subhojit Som, et al. Image as a foreign language: Beit pretraining for all vision and vision-language tasks. arXiv preprint arXiv: 2208. 10442, 2022
Jiahui Yu, Yuanzhong Xu, Jing Yu Koh, Thang Luong, Gunjan Baid, Zirui Wang, Vijay Vasudevan, Alexander Ku, Yinfei Yang, Burcu Karagol Ayan, et al. Scaling autoregressive models for content-rich text-to-image generation. arXiv preprint arXiv: 2206.10789, 2022.
Hai Pham, Paul Pu Liang, Thomas Manzini, Louis-Philippe Morency, and Barnabás Poczos. Found in translation: Learning robust joint representations by cyclic translations between modalities. In 33th AAAI Conference on Artificial Intelligence, pages 6892-6899. AAAI, 2019.
Scott Reed, Konrad Zolna, Emilio Parisotto, Sergio Gomez Colmenarejo, Alexander Novikov, Gabriel Barth-maron, Mai Giménez, Yury Sulsky, Jackie Kay, Jost Tobias Springenberg, Tom Eccles, Jake Bruce, Ali Razavi, Ashley Edwards, Nicolas Heess, Yutian Chen, Raia Hadsell, Oriol Vinyals, Mahyar Bordbar, and Nando de Freitas. A generalist agent. Transactions on Machine Learning Research (TMLR), 2022.
Mike Schuster and Kaisuke Nakajima. Japanese and korean voice search. In 2012 IEEE international conference on acoustics, speech and signal processing (ICASSP), pages 5149-5152. IEEE, 2012.
Rico Sennrich, Barry Haddow, and Alexandra” Birch. Neural machine translation of rare words with subword units. In 54th Annual Meeting of the Association for Computational Linguistics (ACL), pages 1715-1725. Association for Computational Linguistics, 2016.
Aditya Ramesh, Mikhail Pavlov, Gabriel Goh, Scott Gray, Chelsea Voss, Alec Radford, Mark Chen, and Ilya Sutskever. Zero-shot text-to-image generation. In International Conference on Machine Learning (ICML), pages 8821-8831. PMLR, 2021.
Ali Razavi, Aaron Van den Oord, and Oriol Vinyals. Generating diverse high-fidelity images with vq-vae-2. In Advances in Neural Information Processing Systems (NeurIPS), volume 32, 2019
Aaron Van Den Oord, Oriol Vinyals, et al. Neural discrete representation learning. In Advances in Neural Information Processing Systems (NeurIPS), volume 30, 2017.
Danny Driess, Fei Xia, Mehdi S M Sajadi, Corey Lynch, Aakanksha Chowdhery, Brian Ichter, Ayzaan Wahid, Jonathan Tompson, Quan Vuong, Tianhe Yu, et al. Palm-e: An embodied multimodal language model. arXiv preprint arXiv: 2303.03378, 2023.
Thomas Wang, Adam Roberts, Daniel Hesslow, Teven Le Scao, Hyung Won Chung, Iz Beltagy, Julien Launay, and Colin Raffel. What language model architecture and pretraining objective works best for zero-shot generalization? In International Conference on Machine Learning (ICML), pages 22964-22984. PMLR, 2022
Jun-Yan Zhu, Taesung Park, Phillip Isola, and Alexei A Efros. Unpaired image-to-image translation using cycle-consistent adversarial networks. In IEEE International Conference on Computer Vision (ICCV), pages 2223-2232, 2017
Hai Pham, Paul Pu Liang, Thomas Manzini, Louis-Philippe Morency, and Barnabás Poczos. Found in translation: Learning robust joint representations by cyclic translations between modalities. In 33th AAAI Conference on Artificial Intelligence, pages 6892-6899. AAAI, 2019
Hitomi Yanaka, Koji Mineshima, and Kentaro Inui. Exploring transitivity in neural nli models through veridicality. In 16th Conference of the European Chapter of the Association for Computational Linguistics, pages 920-934. Association for Computational Linguistics, 2021
Zack Thoutt. Wine reviews: 130 k wine reviews with variety, location, winery, price, and description. https://www.kaggle.com/datasets/zynicide/wine-reviews, 2018.
John N Weinstein, Eric A Collisson, Gordon B Mills, Kenna R Shaw, Brad A Ozenberger, Kyle Ellrott, Ilya Shmulevich, Chris Sander, and Joshua M Stuart. The cancer genome atlas pan-cancer analysis project. Nature Genetics, 45(10): 1113-1120, 09 2013.
Alex Wang and Kyunghyun Cho. Bert has a mouth, and it must speak: Bert as a markov random field language model. arXiv preprint arXiv: 1902.04094, 2019.
Poli, M. et al. 2023b. StripedHyena: Moving Beyond Transformers with Hybrid Signal Processing Models. github.com/togethercomputer/stripedhyena. doi: 10.57967/hf/1595. December 2023.
Lieber et al. 2024. Jamba: A Hybrid Transformer-Mamba Language Model. arXiv: 2403. 19887. Thu, 28 Mar. 2024
De et al. 2024. Griffin: Mixing Gated Linear Recurrences with Local Attention for Efficient Language Models. arXiv: 2402.19427v1 [cs.LG] 29 Feb. 2024
Tschannen et al. 2023. GIVT: Generative Infinite-Vocabulary Transformers. arXiv: 2312.02116. Mon, 4 Dec. 2023.
BehnamGhader et al. 2024. LLM2Vec: Large Language Models Are Secretly Powerful Text Encoders. arXiv: 2404.05961v1 [cs. CL] 9 Apr. 2024
Yang et al. 2020. XLNet: Generalized Autoregressive Pretraining for Language Understanding. arXiv: 1906.08237v2 [cs. CL] Thu, 2 Jan. 2020
Dong et al. 2019. Unified Language Model Pre-training for Natural Language Understanding and Generation. arXiv: 1905.03197. Tue, 15 Oct. 2019
Raffel et al. 2023. Exploring the Limits of Transfer Learning with a Unified Text-to-Text Transformer arXiv: 1910.10683v4 [cs.LG] Tue, 19 Sep. 2023
Tay et al. 2023. UL2: Unifying Language Learning Paradigms. arXiv: 2205.05131v3 [cs. CL] Tue, 28 Feb. 2023
Mikel Artetxe, Jingfei Du, Naman Goyal, Luke Zettlemoyer, and Ves Stoyanov. On the role of bidirectionality in language model pre-training. arXiv preprint arXiv: 2205.11726, 2022.
Akari Asai and Hannaneh Hajishirzi. Logic-guided data augmentation and regularization for consistent question answering. In 58th Annual Meeting of the Association for Computational Linguistics, pages 5642-5650. Association for Computational Linguistics, 2020.
Mohammad Bavarian, Heewoo Jun, Nikolas Tezak, John Schulman, Christine McLeavey, Jerry Tworek, and Mark Chen. Efficient training of language models to fill in the middle, 2022.
Daniel Fried, Armen Aghajanyan, Jessy Lin, Sida Wang, Eric Wallace, Freda Shi, Ruiqi Zhong, Scott Yih, Luke Zettlemoyer, and Mike Lewis. Incoder: A generative model for code infilling and synthesis. In 11th International Conference on Learning Representations (ICLR), 2023.
Ho-Hsiang Wu, Prem Seetharaman, Kundan Kumar, and Juan Pablo Bello. Wav2clip: Learning robust audio representations from clip. In 2022-2022 IEEE International Conference on Acoustics, Speech and Signal Processing (ICASSP), pages 4563-4567. IEEE, 2022
Lili Yu, . . . , and Armen Aghajanyan. Scaling autoregressive multi-modal models: Pretraining and instruction tuning. Technical report, Meta AI, 2023.

All references cited herein are incorporated herein by reference in their entirety and for all purposes to the same extent as if each individual publication or patent or patent application was specifically and individually indicated to be incorporated by reference in its entirety.

1. A computer-implemented method comprising:
obtaining an input data set comprising data from one or more modalities selected from a set of at least three modalities; and
generating an output data set by processing the input data set using a machine learning model comprising a transitive and commutative machine-learning model,
wherein a transitive and commutative machine-learning model is a machine learning model that has been trained to transform input data sets corresponding to any and each of the modalities of the set of least three modalities to output data sets of any and each other of the modalities of the set of at least three modalities, wherein the machine learning model has been trained to transform data between two modalities by using training data that includes data pairs corresponding to a first of the two modalities and another modality and other data pairs corresponding to the other modality and a second of the two modalities, and the machine learning model has been trained to perform a corresponding reverse type of modality transformation for any forward type of modality transformation that the model has been trained to perform.

2. The method of claim 1, wherein the machine learning model is a classification model, a regression model or a generative model, wherein:
the classification model comprises the transitive and commutative machine-learning model configured to take as input the input dataset, and a trained classification model trained to take as input extracted features from the transitive and commutative machine-learning model and produce as output a classification for the input dataset;
the generative model is trained to take as input the input dataset and produce as output a generated output data set corresponding to the input data set, wherein the output data set corresponds to a modality of the set of at least three modalities that is not present in the input dataset; or
the regression model comprises the transitive and commutative machine-learning model configured to take as input the input dataset, and a trained regression model trained to take as input extracted features from the transitive and commutative machine-learning model and produce as output a regression value for the input dataset, optionally wherein the regression model is a Cox Proportional-Hazards Model and the regression value is a survival prediction.

3. The method of claim 1, wherein the method comprises determining a particular input modality of the input data set, and receiving an indication of a particular target output modality; and generating an output data set is performed by processing the input data set and the identification of the particular target output modality using the transitive and commutative machine-learning model.

4. The method of claim 1, wherein the transitive and commutative machine-learning model has been trained using causal generative modeling, masked modeling and/or variations thereof, optionally wherein said variation is causal masked modeling, wherein:
said causal generative modelling, masked modeling, and/or variation thereof used ground truth data that comprised, for each of a plurality of data pairs in the training data, concatenated input data for a first modality and a second modality of a data pair,
wherein the modality of the data pair used as the first modality was randomly sampled from the two modalities of the data pair and/or the ground truth data comprised for each of the plurality of data pairs in the training data first concatenated input data and second concatenated input data wherein the modality of the data pair used as the first modality is different between the first concatenated input data and second concatenated input data.

5. The method of claim 1, wherein the transitive and commutative machine-learning model has been trained using causal masked modelling, wherein said causal masked modeling comprised:
identifying a subset of tokens in a training data set, wherein the tokens in subset of tokens are at multiple positions within the training data set;
appending the training data set with the subset of tokens; and
adding masks at the multiple positions within the training data set.

6. The method of claim 5, wherein said causal masked modeling further comprised using an identification of the multiple masked positions during the training.

7. The method of claim 1, the transitive and commutative machine-learning model is a sequence model, and/or wherein the transitive and commutative machine-learning model is a deep learning model, and/or wherein the transitive and commutative machine-learning model comprises a sequence model selected from a recurrent neural network, a model combining recurrence and attention mechanisms, a convolutional neural network or a convolution-based model, optionally a model combining elementwise multiplication (gating) and long convolutions or a model combining convolutions and attention mechanisms, a state-space model or a model combining a state-space model and attention mechanisms, or a transformer-based model.

8. The method of claim 1, wherein the transitive and commutative machine-learning model includes a Transformer model that uses self-attention.

9. The method of claim 1, wherein obtaining the input data set comprises:
receiving an initial data set; and
generating the input data set by tokenizing the initial data set.

10. The method of claim 9, wherein generating the input data set comprises one or more of:
(i) tokenizing the initial data set and projecting the tokenised initial data set into a predetermined feature space using a parameterized embedding function for each modality; (ii) prepending and/or appending a modality specific token to the tokenised and optionally projected data corresponding to each single modality in the input data set; and (iii) including learned positional embeddings.

11. The method of claim 1, the transitive and commutative machine-learning model has been trained using a first step using commutative modeling and a self-supervised learning objective, and a second step in which the machine learning model weights are initialized to the weights learned in the first step and further trained using transitive modeling.

12. The method of claim 11, wherein the first step comprised training the model to take as input a partially masked concatenated input data for a first modality and a second modality of a data pair in a training data set comprising ground truth data for a plurality of data pairs each comprising corresponding data for a pair of modalities, and produce as output a prediction of the masked input data, wherein the modality of the data pair used as the first modality was randomly sampled from the two modalities of the data pair and/or the ground truth data comprised for each of the plurality of data pairs in the training data first concatenated input data and second concatenated input data wherein the modality of the data pair used as the first modality is different between the first concatenated input data and second concatenated input data; and/or
wherein the second step comprised training the model to, for each of a plurality of data pairs of a training dataset, each comprising first data for a first modality and corresponding second data for a second modality of the set of at least three modalities:
predicting third data for a third modality of the set of at least three modalities corresponding to the second data using the machine-learning model taking as input the second data;
optionally iteratively predicting subsequent data for a further modality of the set of at least three modalities corresponding to the predicted third data or predicted subsequent data using the transitive and commutative machine-learning model taking as input the predicted third data or predicted subsequent data;
predicting final data for the first modality corresponding to the predicted third data or latest iteratively predicted subsequent data using the transitive and commutative machine-learning model taking as input the third data or latest iteratively predicted subsequent data; and
computing a loss that compares the first data and the predicted final data;
wherein the training data comprised: (i) pairs comprising data for the second modality and corresponding data for the third modality, and (ii) pairs comprising data for the third modality and corresponding data for the first modality, or pairs comprising data for the latest further modality and corresponding data for the first modality and respective pairs comprising data for each of the two modalities used in the step of iteratively predicting subsequent data for a further modality.

13. The method of claim 1, wherein the transitive and commutative machine-learning model has been trained using a method including:
accessing a training data set that included first data of a particular input modality and corresponding second data of another modality;
generating a first predicted output data set by processing the first data and an identification of the other modality using the transitive and commutative machine-learning model, wherein the first predicted output data set corresponds to the other modality;
generating a second predicted output data set by processing the first predicted output data and an identification of the particular target output modality using the transitive and commutative machine-learning model, wherein the second predicted output data set corresponds to the particular target output modality;
generating a third predicted output data set by processing the second predicted output data and an identification of the particular input modality using the transitive and commutative machine-learning model, wherein the third predicted output data set corresponds to the particular input modality; and
computing a loss by comparing at least part of the third predicted output data set to the first data.

14. The method of claim 1, wherein the transitive and commutative machine-learning model has been trained using training data that lacked data associating first data of a particular input modality with second data of a particular output modality, and/or
wherein the transitive and commutative machine-learning model has been trained using training data that comprised data associating data of pairs of modalities of the set of at least three modalities, wherein for each pair of a first and second modality of the set of at least three modalities, the training data comprised data associating data of pairs of modalities that together form a path between the first and second modality, optionally wherein for each pair of a first and second modality of the set of at least three modalities, the training data comprised data associating data of the first modality with a third modality and data associating data of the third modality with the second modality.

15. The method of claim 1, wherein the transitive and commutative machine-learning model has been trained to learn a first conditional distribution (P(C|A), P(A|C)) of a pair of modalities (A, C) for which the training data did not contain sufficient training data pairs associating data of the pair of modalities to parameterise the conditional distribution, by predicting data for one or more additional modalities (B) forming a link between the pair of modalities using learned further conditional distributions (P(C|B)) of pairs of modalities (C, B) forming said link and for which the training data did contain sufficient training data pairs associating data of the pair of modalities to parameterise the further conditional distributions.

16. The method of claim 1, wherein the transitive and commutative machine-learning model has been trained using a method including, for each data pair of the training data comprising data pairs comprising first data for a first modality and corresponding second data for a second modality of the set of at least three modalities:
predicting third data for a third modality of the set of at least three modalities corresponding to the second data using the transitive and commutative machine-learning model taking as input the second data;
optionally iteratively predicting subsequent data for a further modality of the set of at least three modalities corresponding to the predicted third data or predicted subsequent data using the transitive and commutative machine-learning model taking as input the predicted third data or predicted subsequent data;
predicting final data for the first modality corresponding to the predicted third data or latest iteratively predicted subsequent data using the transitive and commutative machine-learning model taking as input the third data or latest iteratively predicted subsequent data; and
computing a loss that compares the first data and the predicted final data;
wherein the training data comprised: (i) pairs comprising data for the second modality and corresponding data for the third modality, and (ii) pairs comprising data for the third modality and corresponding data for the first modality, or pairs comprising data for the latest further modality and corresponding data for the first modality and respective pairs comprising data for each of the two modalities used in the step of iteratively predicting subsequent data for a further modality.

17. The method of claim 1, wherein the transitive and commutative machine-learning model has been trained using training data comprising tuples (e.g. pairs) comprising corresponding data for multiple modalities of the set of at least three modalities, wherein the tuples including data for a specific pair of modalities of the set of at least three modalities were present in the training data at less than 50%, less than 40%, less than 30%, less than 20%, less than 10%, less than 5% or less than 1% of the number of tuples including data for all other pairs of modalities of the set of at least three modalities, optionally wherein the tuples did not comprise tuples that include data for a specific pair of modalities of the set of at least three modalities.

18. The method of claim 1, wherein the method further comprises training the machine learning model.

19. The method of claim 1, wherein the one or more modalities are selected from medical or biological sample data associated with a subject, optionally wherein the one or more modalities are selected from: medical image data, electronic-medical-record data, genetic sequence data, and digital pathology image data, optionally wherein medical image data is selected from MRI, CT or PET imaging data.

20. The method of claim 1, wherein the machine learning model is configured to take as input medical or biological sample data associated with a subject and produce as output an indication of a treatment that is recommended for the subject, optionally wherein the indication is a classification and/or wherein the medical or biological sample data comprises one or more of: as radiological images, genetic sequences, and microscopic slides.

21-32. (canceled)
